(19) United States
(12) Patent Application Publication
(10) Pub. No.: US 2010/0257156 A1
(43) Pub. Date: Oct. 7, 2010

(54) MOVING PICTURE INDEXING METHOD AND MOVING PICTURE REPRODUCING DEVICE

(76) Inventors: Kazushige Hiroi, Machida (JP); Masayuki Oyamatsu, Misato (JP); Maki Furui, Tokyo (JP); Kenji Katsumata, Yokohama (JP); Hidekazu Takeda, Hiratsuka (JP); Takehito Kishi, Yokohama (JP); Takanori Eda, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/729,847

(22) Filed: Mar. 23, 2010

(30) Foreign Application Priority Data
Apr. 7, 2009 (JP) 2009-092572

(51) Int. Cl. G06F 17/30; G06F 3/01

(52) U.S. Cl. 707/722; 707/741; 707/E17.002; 715/720

(57) ABSTRACT

A movie data indexing apparatus of the present invention comprises a movie data scene character data input processing unit, a movie data genre decision processing unit, a formatted phrase keyword dictionary input processing unit for inputting a formatted phrase keyword dictionary inherent to the determined movie data genre, a movie data information input processing unit, a movie data inherent dictionary generation processing unit for generating a dictionary inherent to the movie data, a scene character string coding processing unit for encoding a character string for a scene of the movie data, a proposal keyword dictionary for formatted phrase input processing unit for inputting a dictionary prescribing keywords, and a scene indexing processing unit for performing indexing to a scene of the movie data on the basis of the scene character string coded data, the movie data inherent dictionary and the proposal keyword dictionary for formatted phrase.

### INCORPORATION BY REFERENCE

The present application claims priority from Japanese application JP 2009-092572 filed on Apr. 7, 2009, the content of which is hereby incorporated by reference into this application.

### BACKGROUND OF THE INVENTION

The present invention relates to an indexing method for applying an index to a scene for movie data and a playback apparatus for movie data and more particularly, to a movie data playback apparatus adapted to select a scene utilizing a movie data distribution service in which movie data of a television, a recorder, a PC and the like capable of recording and reproducing movie data is distributed while applying an index to the movie data and utilizing an index.

### BACKGROUND ART

Viewable movie data such as ground wave digital, BS, CS or net movie data has been increasing. In addition, with the HDD increased in capacity and the movie data compression technique advanced, the retainable amount of movie data the user retains in an apparatus has been increasing. But no matter how the amount of viewable movie data increases, the time per se allowing the user for viewing remains unchanged and limited and therefore, a scheme for efficiently viewing movie data is needed.

Known as a technique offering this type of scheme is a technique for generation and reproduction of a digest motion picture of the movie data as disclosed in, for example, D. DeMenthon, V. Kobla, and D. Doermann, “Video Summarization by Curve Simplification”, ACM Multimedia 98, Bristol, England, pp. 211-218, 1998 and JP-A-2006-180305.

Further, as disclosed in JP-A-2009-4872, subtitle data concomitant to movie data is retained and a scene containing as a subtitle a character string inputted by the user is searched and displayed.

Further, JP-A-2008-134825 discloses a technique in which a keyword is extracted from subtitle data concomitant to movie data and a caption is added to a scene of the movie data, permitting the user to view a desired scene with ease.

Furthermore, JP-A-2008-22292 discloses a technique, according to which as movie data, a broadcasting program is especially targeted and on the basis of program information and subtitle information under consideration of the genre of the broadcasting program, a scene showing a performer the user desires appearing on the stage can be searched and viewed.

### SUMMARY OF THE INVENTION

As described above, techniques for efficient viewing of movie data have been disclosed but, for example, in the technique disclosed in D. DeMenthon, V. Kobla, and D. Doermann, “Video Summarization by Curve Simplification”, ACM Multimedia 98, Bristol, England, pp. 211-218, 1998 and JP-A-2006-180305, video and audio data in movie data need to be processed, thus imposing a large load on the hardware resources and especially, in a packaging apparatus such as a television optimized for costs, there arises a problem of encountering difficulties in incorporating the technique. The technique enables a digest motion picture of movie data to be viewed but still faces a problem that the user cannot always be allowed to view a desired scene.

On the other hand, in the technique disclosed in JP-A-2009-4872, video image and audio data need not be processed and only subtitle text data is processed and so, suppression of the load imposed on the hardware resource can be realized. This technique is, however, problematic in that a desired scene cannot be searched unless the user knows in advance a keyword contained in the movie data. Besides, in inputting the keyword, a character string needs to be inputted directly from a remote controller, for instance, and disadvantageously, operation is complicated.

Further, in the technique disclosed in JP-A-2008-134825, by extracting a keyword from subtitle data accompanying movie data and adding a caption to a scene of the movie data, the user is permitted to designate the keyword selectively so as to view a desired scene but for extraction of the keyword, a form elementary analysis and a meaning analysis need to be carried out, also resulting in a problem that the load imposed on the resource increases.

Furthermore, in the technique disclosed in JP-A-2008-22292, a scene in which a performer the user desires is appearing on the stage can be searched from movie data and viewed but in this case, a dictionary for the performer's name is required and the capacity of memory increases to keep or store the dictionary. Moreover, the dictionary data needs to be updated periodically and manual update incurs costs. Besides, ideally, the dictionary is required to be updated on real time basis, bringing about a problem that it is substantially impossible to perform the update manually by human.

The present invention contemplates solving the above problems and has for its object to provide an apparatus or a method concerning an indexing process which suppresses the load imposed on the hardware resource. Further, the present invention aims at providing an apparatus, a user interface or a method concerning a movie data playback process using generated indexing data.

Structurally, to solve at least one of the above problems, a movie data indexing method according to an embodiment of the invention comprises the steps of inputting character data concerning a movie data scene, deciding a genre of the movie data, encoding a character string corresponding to the scene of the movie data on the bass of a formatted phrase keyword dictionary inherent to the determined movie data genre and the character data concerning the inputted movie data scene, and generating indexing data for the scene of the movie data on the basis of a dictionary prescribing a proposal keyword and the scene character string coded data.

According to a second embodiment, a dictionary inherent to movie data is generated, a character string corresponding to a scene of the movie data is encoded on the basis of the generated movie data inherent dictionary and character data of the inputted movie data scene, and indexing data corresponding to the scene of the movie data is generated on the basis of the scene character string coded data and the generated movie data inherent dictionary.

According to a third embodiment, a dictionary which is inherent to movie genre with a formatted phrase keyword dictionary and a dictionary which is inherent to the movie data with movie data information, a character string corresponding to a scene of the movie data is encoded on the basis of the generated movie data inherent dictionary, formatted phrase keyword dictionary and character data concerning the movie data scene, and indexing data corresponding to the scene of the movie data is generated on the basis of a proposal keyword dictionary for formatted phrase which is inputted dictionary for prescribing a keyword for the formatted phrase keyword dictionary, scene character string coded data, generated movie data inherent dictionary and proposal keyword dictionary for formatted phrase.

In a different embodiment, a movie data playback apparatus is constructed in which a keyword list is outputted to a display unit on the basis of indexing data of movie data, an input of a keyword selected by the user from the keyword list is received and a scene of the keyword is captured from the keyword and indexing data, thereby reproducing the scene of the keyword.

According to the present invention, a movie data indexing method is provided according to which only a scene the user wants to watch can be viewed at low costs. Further, a movie data playback apparatus is provided in which a scene the user wants to watch can be selected easily.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a movie data indexing method according to a first embodiment of the present invention.

FIG. 2 is a diagram showing an example of movie data genre descriptive data according to an embodiment of the invention.

FIG. 3A is a diagram showing an example of data structure of a formatted phrase keyword dictionary according to first and third embodiments of the invention.

FIG. 3B is a diagram showing another example of data structure of the formatted phrase keyword dictionary according to the first and third embodiments of the invention.

FIG. 4 is a diagram showing an example of data structure of scene character string coded data according to the first embodiment of the invention.

FIG. 5A is a diagram showing an example of data structure of a proposal keyword dictionary for formatted phrase according to the first and third embodiments of the invention.

FIG. 5B is a diagram showing another example of data structure of the proposal keyword dictionary for formatted phrase according to the first and third embodiments of the invention.

FIG. 6 is a diagram showing an example of data structure of indexing data according to the first embodiment of the invention.

FIG. 7 is a flowchart showing an example of contents of procedures in an indexing method according to the first embodiment of the invention.

FIG. 8 is a diagram illustrative of the indexing method according to the first embodiment of the invention.

FIG. 9 is a block diagram of a movie data playback apparatus according to an embodiment of the invention.

FIG. 10 is a flowchart showing an example of contents of procedures in the movie data playback apparatus according to the embodiment of the invention.

FIG. 11 is a diagram showing an example of a keyword list proposal screen in the movie data playback apparatus according to the embodiment of the invention.

FIG. 12 is a block diagram showing a movie data indexing method according to the second embodiment of the invention.

FIG. 13 is a diagram showing an example of movie data information data according to the second and third embodiments of the invention.

FIG. 14 is a diagram showing an example of data structure of a movie data inherent dictionary according to the second and third embodiments of the invention.

FIG. 15 is a diagram showing an example of data structure of scene character string coded data according to the second embodiment of the invention.

FIG. 16 is a diagram showing an example of data structure of indexing data according to the second embodiment of the invention.

FIG. 17 is a flowchart showing an example of contents of procedures in the indexing method according to the second embodiment of the invention.

FIG. 18 is a diagram illustrative of an indexing method according to the third embodiment of the invention.

FIG. 19 is a block diagram showing a movie data indexing method according to the third embodiment of the invention.

FIG. 20 is a diagram showing an example of data structure of scene character string coded data according to the third embodiment of the invention.

FIG. 21 is a diagram showing an example of data structure of indexing data according to the third embodiment of the invention.

FIG. 22 is a flowchart showing an example of contents of procedures in the indexing method according to the third embodiment of the invention.

FIG. 23 is a diagram illustrative of the indexing method according to the third embodiment of the invention.

FIG. 24 is a diagram showing an example of construction of an indexing apparatus realizing the indexing method.

FIG. 25 is a diagram showing an example of construction of the movie data playback apparatus.

### DESCRIPTION OF THE EMBODIMENTS

### Embodiment 1

A first embodiment of the present invention will be described hereunder with reference to drawings.

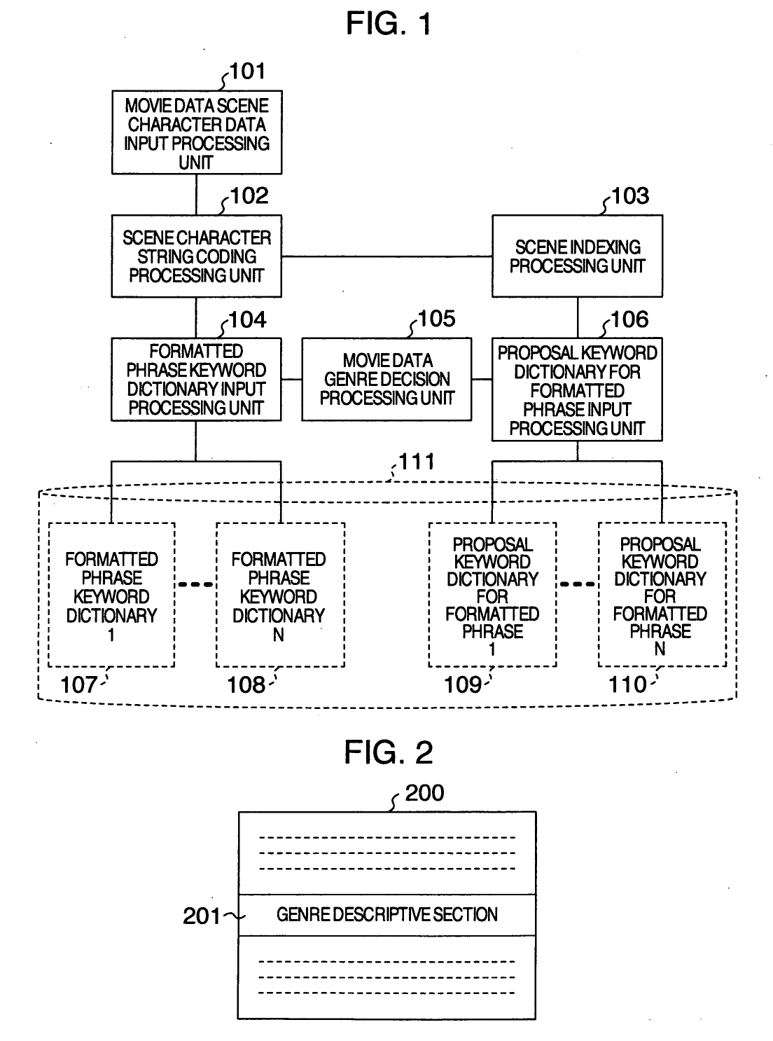

FIG. 1 is a functional block diagram of the first embodiment of the invention.

The functional block shown in FIG. 1 is constituted by a movie data scene character data input processing unit 101, a movie data genre decision processing unit 105, a formatted phrase keyword dictionary input processing unit 104, a scene character string coding processing unit 102, a proposal keyword dictionary for formatted phrase input processing unit 106, a scene indexing processing unit 103, formatted phrase keyword dictionaries 107 to 108 and proposal keyword dictionary for formatted phrase 109 to 110.

The movie data genre decision processing unit 105 decides a genre (music program, variety program and so on) of movie data. Structurally, for example, the genre may be decided by capturing data described with genres in the movie data or if metadata of the movie data is offered, the genre may be decided from genre information by capturing the metadata. Alternatively, SI (Service Information: program information) information of the movie data may be acquired and by making reference to a genre descriptive section of the SI information as shown in FIG. 2 to be described later, a genre of the movie data may be acquired.

FIG. 2 shows contents 200 of SI information, and a genre descriptive section designated by 201 exists at a determined position or at a tagged position.

Then, a genre of movie data is described in the genre descriptive section 201 and for example, when a numerical value meaning a variety (for example, 0x60) is described in the genre descriptive section 201, it can be determined that the genre of the movie data is “variety”. To add, for example, when movie data is a television program and the indexing is to be applied to recorded data of the television program, the SI information may be captured upon initiation of recording, for example, to decide the genre of the movie data.

The movie data genre decision processing unit 105 decides the tag or the predetermined position and captures the genre descriptive section 201.

Reverting to FIG. 1, the movie data scene character data input processing unit 101 inputs character data concerning a movie data scene. Structurally, this can be done by capturing, packet by packet, subtitle data and PTS (Presentation Time Stamp: time to display and reflect subtitle data) concomitant to the movie data in order that conversion from the subtitle data to a character string is effected every packet through the already known subtitle decoding technique and the converted character string is acquired together with its PTS. Alternatively, a telop image overlaid on each of the movie data images may be recognized through the already known OCR (Optical Character Recognition) technique and a time that a character string and a telop of the character string come up when the character string as a result of recognition differs may be acquired. Alternatively, voice in the movie data may be recognized through the already known voice recognition technique, spoken contents may then be converted into a character string, and the character string and a time that the character string is spoken may be captured. Alternatively, metadata containing a description concerning a scene of the movie data may be inputted.

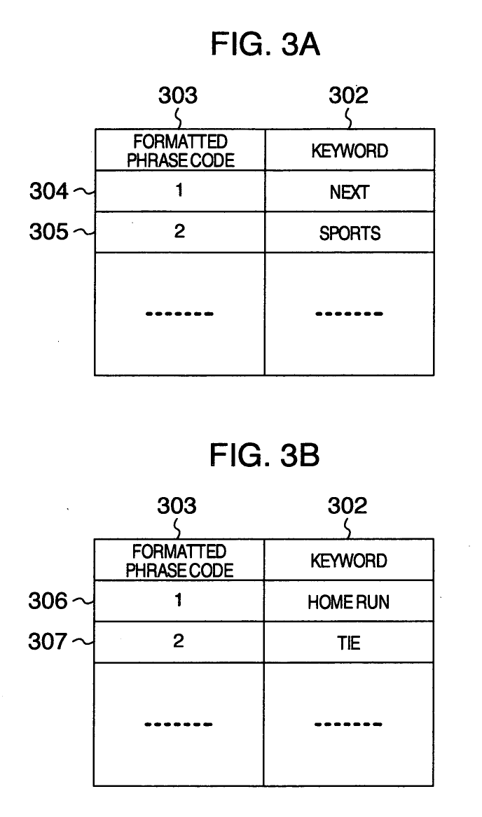

The formatted phrase keyword dictionary input processing unit 104 inputs a formatted phrase keyword dictionary inherent to the movie data genre determined by the movie data genre decision processing unit 105. Structurally, for example, this is done by capturing a formatted phrase keyword dictionary of movie data genre from the formatted phrase keyword dictionary 1 (107) to formatted phrase keyword dictionary N (108) for individual movie data genres which are stored in the memory unit (111) such as, for example, a hard disk or ROM or stored in the information processing unit connected via a network, thereby enabling the scene character string coding processing unit 102 to be described later to consult it. An example of data structure of the formatted phrase keyword dictionary is exemplified in FIGS. 3A and 3B and will be detailed later.

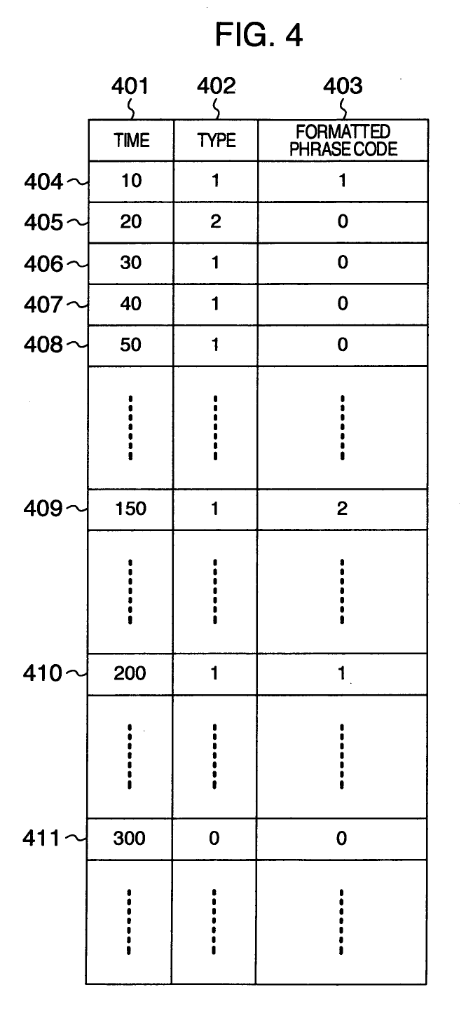

The scene character string coding processing unit 102 encodes a character string corresponding to a scene of movie data on the basis of the formatted phrase keyword dictionary inputted by the aforementioned formatted phrase keyword dictionary input processing unit 104 and the movie data scene character data inputted by the aforementioned movie data scene character data input processing unit 101 as well. For example, the scene character string coding processing unit 102 collates each packet of movie data scene character data inputted by the movie data scene character data input processing unit 101 with the formatted phrase keyword dictionaries 107, 108 inputted by the formatted phrase keyword dictionary input processing unit 104 and when a keyword described in the formatted phrase keyword dictionaries comes up in the movie data scene character data, it encodes the movie data scene character data of the packet together with a PTS of the movie data scene character data of the packet. For more details, for example, when the formatted phrase keyword dictionary describes that a keyword of “next” is to be encoded to a formatted phrase code “1” in the formatted phrase keyword dictionaries 107, 180 to be detailed later, the scene character string coding processing unit 102 searches the character string termed “next” in respect of individual packets of movie data scene character data and when the character string is found, the scene character string coding processing unit 102 generates scene character string coded data by describing the formatted phrase code “1”, together with the PTS of the packet of the movie data scene character data, as scene character string coded data as shown in FIG. 4 to be described later in greater detail. At that time, in case any keyword in the formatted phrase keyword dictionary comes up, the scene character string coding processing unit 102 generates scene character string coded data as a result of encoding throughout the whole packets. A packet in which any keyword in the formatted phrase keyword dictionary has not come up need not always be included in the scene character string coded data but it may be included in the scene character string coded data by describing a formatted phrase code not prescribed in the formatted phrase keyword dictionary (for example, “0”). Further, this scene character string coding processing unit 102 may encode information usable regardless of the movie data genre, such as specified character string and mark (for example, musical note mark) or a packet of control code indicative of erase of character string, as codes “2”, “1” and “0”, respectively, for example, thus enabling the genre of the packet to be contained in the scene character string coded data. In any case, this scene character string coding processing unit 102 collates all packets of movie data scene character data in movie data with the formatted phrase keyword dictionary to generate scene character string coded data. The scene character string coding processing unit 102 may retain the thus generated scene character string coded data in a volatile memory or a non-volatile memory and then, may erase it after a lapse of a predetermined time period.

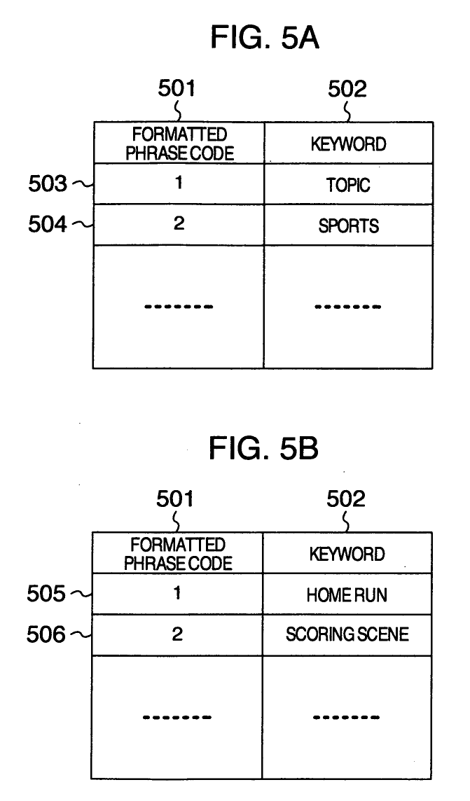

The proposal keyword dictionary for formatted phrase input processing unit 106 inputs a dictionary prescribing keywords to be proposed to scenes in which individual keywords described in the formatted phrase keyword dictionary come up. Structurally, for example, this is done by capturing, in accordance with the movie data genre determined by the movie data genre decision processing unit 105, the proposal keyword dictionary for formatted phrase 1 (109) to the proposal keyword dictionary for formatted phrase N (110) which are stored in the memory unit (111) such as a hard disk or ROM or in the information processing unit connected via, for example, a network so that the scene indexing processing unit 103 to be described later may consult them. An example of data structure of the proposal keyword dictionary for formatted phrase is exemplified in FIG. 5A or 5B and will be described later.

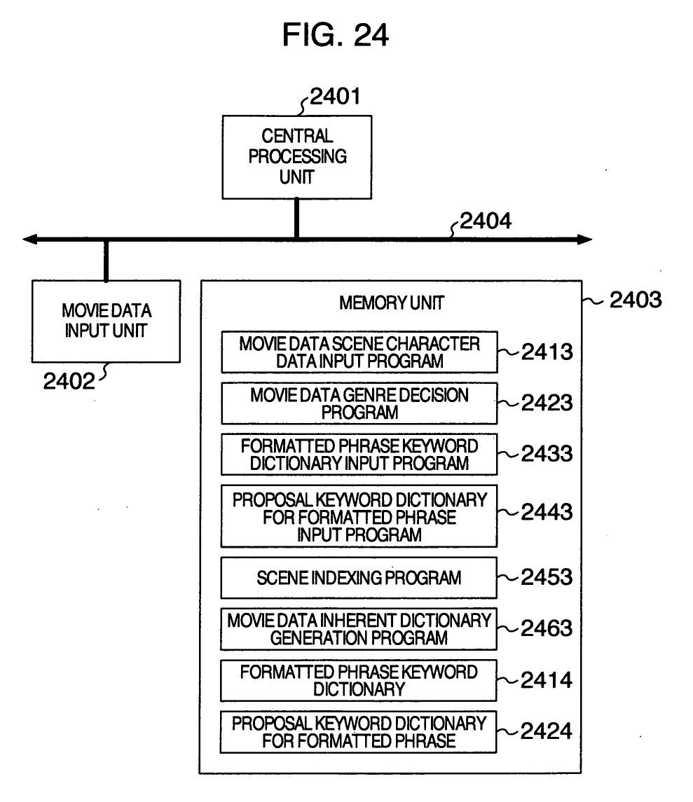

The scene indexing processing unit 103 generates indexing data for the scene of movie data on the basis of the scene character string coded data generated by scene character string coding processing unit 102 and the proposal keyword dictionary for formatted phrase inputted by proposal keyword dictionary for formatted phrase input processing unit 106. For example, to this end, the scene indexing processing unit 103 searches, out of the scene character string coded data generated by scene character string coding processing unit 102, a keyword having the same code value as that in each packet from the proposal keyword dictionary for formatted phrase inputted by proposal keyword dictionary for formatted phrase input processing unit 106, makes a set of the keyword and time information inside the scene character string coded data and describes the set as indexing data. To describe in greater detail, for example, the scene indexing processing unit 103 acquires an entry 404 having a formatted phrase code 403 of “1” from scene character string coded data of FIG. 4 to be detailed later, searches from the proposal keyword dictionary for formatted phrase an entry 503 having the same formatted phrase code 501 as the formatted phrase code “1” and captures a keyword “topic” described in keyword 502. Thereafter, the scene indexing processing unit 103 acquires times “10, 200” of time 401 having the formatted phrase code “1”, treats the keyword “topic”, times “10, 200” and the number of times as indexing data pieces, respectively, and describes them in the keyword 601, time information 603 and position number 602, respectively. By performing this process in respect of genres of all formatted phrase codes 403 in the scene character string coded data, indexing data can be generated. The scene indexing processing unit 103 stores the thus generated indexing data in the memory unit 111. The above is not shown in FIG. 1 but will be described later with reference to FIG. 24. The data structure of indexing data will be described later in greater detail.

Next, data generated in the first embodiment of the invention will be described in greater detail.

Firstly, the data structure of the formatted phrase keyword dictionary inputted by the formatted phrase keyword dictionary input processing unit 104 and consulted by the scene character string coding processing unit 102 will be described.

As described previously, the formatted phrase keyword dictionaries are prepared in respect of individual movie data genres and the formatted phrase keyword dictionary input processing unit 104 is so constructed as to input a dictionary corresponding to a genre of movie data.

FIGS. 3A and 3B show examples of data structure of the formatted phrase keyword dictionary, with FIG. 3A especially showing an example of data structure of the formatted phrase keyword dictionary for movie data of a genre of “news program”. Then, FIG. 3B shows an example of data structure of the formatted phrase keyword dictionary for movie data of a genre of “baseball program”.

In FIGS. 3A and 3B, 303 designates formatted phrase code and 302 designates keyword. Then, 304 to 305 and 306 to 307 designate entries of inherent keywords and entries of formatted phrase codes corresponding thereto. Through this, when the movie data scene character data input processing unit 101 inputs a packet containing a character string purporting “next”, for example, the scene character string coding processing unit 102 generates formatted phrase code “1” as the scene character string coded data.

In the formatted phrase keyword dictionary, the keyword has the univalent correspondence with the genre but the formatted phrase code need not have one to one relation. In other words, the dictionary data may be structured such that while as shown in FIG. 3A, for example, the formatted phrase code “1” is allotted to the keyword “next”, the “1” may similarly be allotted also to a keyword “thereafter” (namely, the formatted phrase code may be duplex).

In this manner, the scene character string coding processing unit 102 allots the formatted phrase code “1” to a packet of movie data scene character data in which “next” comes up and also allots the formatted phrase code “1” to a packet of movie data scene character data in which “thereafter” comes up and subsequently, the scene indexing processing unit 103 may index the same keyword (when the proposal keyword dictionary for formatted phrase in FIG. 5A to be described later is used, a keyword “topic”) at the time for either packet.

Next, the data structure of scene character string coded data generated by the scene character string coding processing unit 102 and consulted by the scene indexing processing unit 103 will be described.

FIG. 4 shows an example of data structure of the scene character string coded data.

In FIG. 4, 401 designates the time of each packet of movie data scene character string data, in which a PTS of each packet may be entered. Then, 402 designates the type of data contained in each packet of the movie data scene character data and indicates values for encoding information usable regardless of the movie data genre such as for example, “1” in the case of a normal character string, “2” in the case of containing musical note marks and “0” in the case of containing only a specified control code such as a control code indicative of clearing displayed character string. Further, 403 designates the fields for storing formatted phrase codes and when keywords of formatted phrase keyword dictionary are contained in individual packets of the movie data scene character data, their coded values are entered. Structurally, especially when a keyword 302 of the formatted phrase keyword dictionary is found in each packet of the movie data scene character data, a value of formatted phrase code 303 corresponding to the keyword is inputted. In case the keyword 302 of formatted phrase keyword dictionary is not found, a value not prescribed by the formatted phrase code 303 of the formatted phrase keyword dictionary (for example, “0” in the examples of dictionary of FIGS. 3A and 3B) may be inputted. Further, 404 to 411 designate entries of the scene character string coded data and values corresponding to individual packets of the movie data scene character data are enumerated in the entries. More particularly, in the examples of FIG. 3A and FIG. 4, the movie data scene character data input processing unit 101 inputs at the entry 404 a packet of a normal character string added with a PTS of time “10”, demonstrating that a character string “next” was contained in the packet. Similarly, the entries 405, 406 and 409 have meanings as below, respectively.

At the entry 405, “A packet containing a musical note mark added with a PTS of “20” was inputted and a keyword prescribed by the formatted phrase keyword dictionary was not contained in this packet.” is meant.

At the entry 406, “A packet containing a normal character string added with a PTS of “30” was inputted and a keyword prescribed by the formatted phrase keyword dictionary was not contained in this packet.” is meant.

At the entry 409, “A packet containing a normal character string added with a PTS of “150” was inputted and a character string “Sports.” was contained in this packet.” is meant.

To add, the scene character string coding processing unit 102 may encode data contained in all packets inputted by the movie data scene character data input processing unit 101. Alternatively, the scene character string coding processing unit 102 may encode only a packet having contained a keyword of the formatted phrase keyword dictionary. With the present scene character string coding processing unit 102, the character string per se of movie data scene character data need not be retained, leading to an advantage that the capacity of the memory to be used can be reduced significantly. Further, since the character string per se of movie data scene character data is not retained, a construction desirable from the viewpoint of protection of copyright can be set up.

Next, the data structure of the proposal keyword dictionary for formatted phrase inputted by the proposal keyword dictionary for formatted phrase input processing unit 106 and consulted by the scene indexing processing unit 103 will be described.

As described previously, structurally, a proposal keyword dictionary for formatted phrase is prepared for each movie data genre so that a proposal keyword dictionary for formatted phrase corresponding to a movie data genre may be inputted by means of the proposal keyword dictionary for formatted phrase input processing unit 106.

FIGS. 5A and 5B show examples of data structure of the formatted phrase keyword dictionary with FIG. 5A especially showing an example of data structure of the proposal keyword dictionary for formatted phrase for movie data of a genre of “news”. Then, FIG. 5B shows an example of data structure of the proposal keyword dictionary for formatted phrase for movie data of a genre of “baseball”.

In FIGS. 5A and 5B, 501 designates a formatted phrase code and 502 designates proposal keyword. Then, 503 to 504 and 505 to 506 designate entries of proposal keyword dictionary for formatted phrase and each of them makes a set of a formatted phrase code 501 and a keyword 502 proposed at a position of time at which the formatted phrase code, if found, comes up. Through this, in the case of the movie data of news programs, for example, the proposal keyword dictionary for formatted phrase of FIG. 5A is inputted by means of the proposal keyword dictionary for formatted phrase input processing unit 106 and when the movie data scene character data input processing unit 101 inputs a packet containing a character string “next”, the scene character string coding processing unit 102 writes formatted phrase code “1” and time “10” into the scene character string coded data, thus enabling the scene indexing processing unit 103 to generate indexing data as a keyword “topic” at a position of time “10”. To add, a plurality of keywords may correspond to a single formatted phrase code.

Next, the data structure of indexing data generated by the scene indexing processing unit 103 will be described.

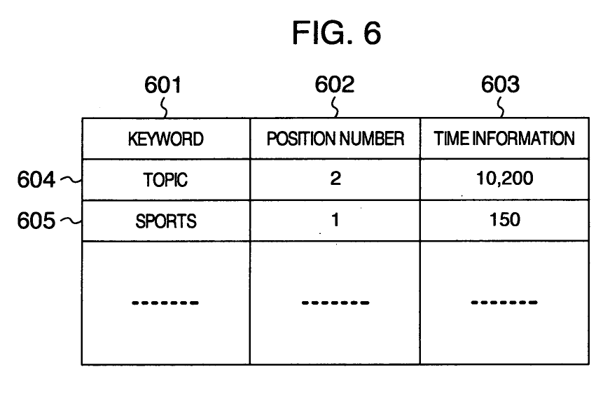

FIG. 6 shows an example of data structure of indexing data.

In FIG. 6, 601 designates keyword of a scene corresponding to the keyword 502 prescribed by the proposal keyword dictionary for formatted phrase Designated by 602 is the number of positions where the keyword 601 is applied. Designated by 603 is time information for position number 602 applied with the keyword 601. Then, 604 to 605 designate entries of indexing data each making, in respect of keyword 601, a set of position number 602 at which the keyword is applied and time information 603.

This data structure can be generated by the scene indexing processing unit 103 which captures a formatted phrase code 403 and a time 401 from scene character string coded data, counts a position number by counting the number of entries each having a formatted phrase code of the same value as the formatted phrase code of interest, acquires a keyword 502 having the formatted phrase code 501 of the same value as the formatted phrase code of interest, and describes the keyword 502, the position number counted previously and the individual times in 601, 602 and 603, respectively. With the present indexing data, the movie data playback apparatus consulting the indexing data of interest can display the keyword such as “topic”, “sports” and the like and when a keyword is selected by the user, it can display or reproduce the position of a scene of the keyword.

Next, flow of the overall process in the movie data indexing method according to the first embodiment of the invention will be described.

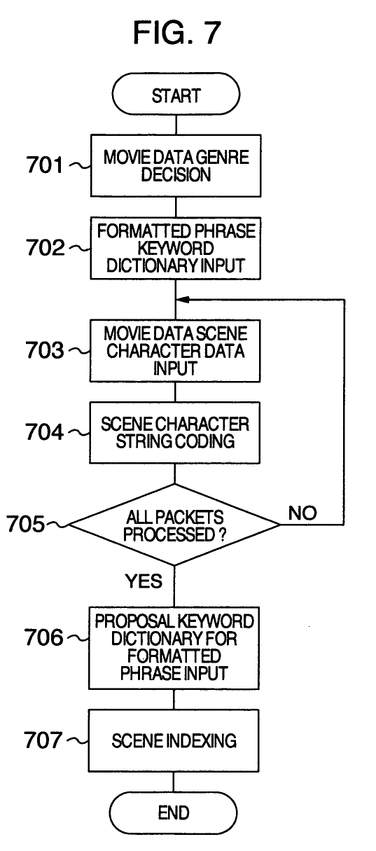

FIG. 7 is a flowchart for explaining an example of flow of the overall process in the movie data indexing method according to the first embodiment of the invention.

Firstly, the movie data genre decision processing unit 105 decides a genre of movie data (step 701) and the formatted phrase keyword dictionary input processing unit 104 reads out of the memory unit 111 a formatted phrase keyword dictionary inherent to the movie data genre determined in step 701 and inputs it (step 702). Subsequently, the movie data scene character data input processing unit 101 inputs, packet by packet, character data concerning a movie data scene (movie data scene character data) (step 703), and the scene character string coding processing unit 102 encodes the movie data scene character data of the packet inputted in step 703 by consulting the formatted phrase keyword dictionary inputted in step 702 to thereby generate scene character string coded data (step 704).

Then, after the movie data scene character data pieces of all packets in the movie data have been encoded by repeating the steps 703 and 704 (step 705), the proposal keyword dictionary for formatted phrase input processing unit 106 inputs a proposal keyword dictionary for formatted phrase corresponding to the formatted phrase keyword dictionary inherent to the movie data genre determined in step 701 (namely, prescribing a keyword proposed against the formatted phrase keyword dictionary) (step 706), and the scene indexing processing unit 103 performs indexing, in respect of the scene of movie data, on the basis of the scene character string code generated in step 704 and the proposal keyword dictionary for formatted phrase inputted in step 706 to thereby generate indexing data and stores it in the memory unit 111.

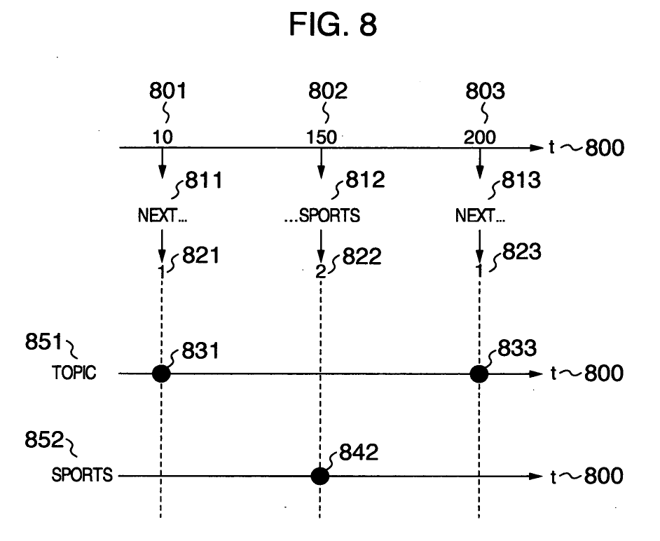

For example, for movie data having a category of news, movie data scene character data at times “10” 801 and “200” 803 at which character strings 811 and 813 purporting “next” come up in the movie data scene character data are encoded as formatted phrase code “1” 821 and 823, as shown in FIG. 8. Further, movie data scene character data at time “150” 802 at which a character string 812 purporting “Sports.” comes up in the movie data scene character data is encoded as a formatted phrase code “2” 822, so that in comparison with the case of retaining a character string per se, the used memory capacity can be reduced. Further, indexing data applied with an index of keyword “topic” 851 is generated at the position where the character strings 811 and 813 purporting “next” come up in the movie data scene character data and besides, indexing data applied with an index of keyword “sports” 852 is generated at the position where the character string 812 purporting “Sports.” comes up in the movie data scene character data.

Then, when, in the playback unit reading the present indexing data, the keywords “topic” 851 and “sports” 852 are proposed to the user and the keyword “topic” 851 is designated by the user as will be described later, playback from the scene corresponding to the keyword “topic” 851 can be achieved by reproducing movie data from the positions of time “10” 801 or “200” 803. Similarly, when the user designates the keyword “sports” 852, playback from the scene corresponding to the keyword “sports” 852 can be achieved by reproducing movie data from the position of time “150” 802. In FIG. 8, 800 designates time axis and 801, 802 and 803 designate positions of times “10”, “150” and “200” on time axis, respectively. Further, 811, 812 and 813 designate character strings contained in packets of movie data scene character data coming up at times “10” 801, “150” 802 and “200” 803, respectively, and 821, 822 and 823 designate formatted phrase code values of movie data scene character data pieces 821, 822 and 823, respectively. Further, 831 and 833 designate points where a scene of keyword “topic” 851 is plotted on time axis and 832 designates a point where a scene of keyword “sports” 851 is plotted on time axis.

According to the movie data indexing method according to the first embodiment of the invention set forth so far, the load on the hardware resource can be suppressed and by applying a keyword to a scene of movie data and proposing the keyword, indexing data which permits only a scene desired for watching to be viewed from the movie data can be generated when the user designates the keyword. Further, in extracting the keyword corresponding to the scene of movie data, dictionary data can be minimized as far as possible to decrease the capacity of the memory retaining the dictionary data as far as possible and manual update of the dictionary data can be dispensed with.

Next, a playback apparatus for movie data according to an embodiment of the present invention will be described with reference to the drawings.

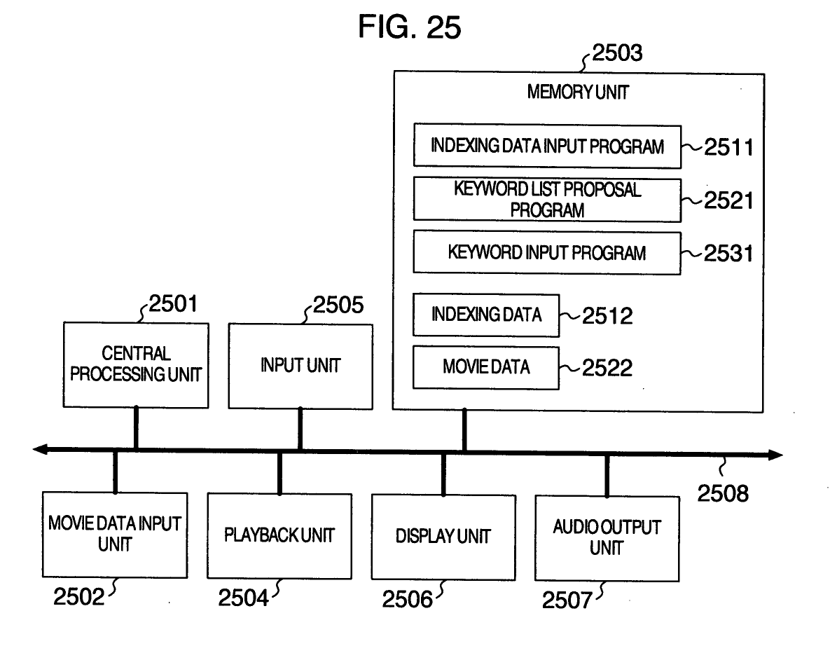

FIG. 25 shows an example of hardware construction of the movie data playback apparatus according to the embodiment of the invention. In FIG. 25, the apparatus is constituted by having a central processing unit 2501, a movie data input unit 2502, a memory unit 2503, a playback unit 2504, an input unit 2505, a display unit 2506 and a audio output unit 2507. Then, the individual units are coupled together by a bus 2508 to enable data to be transmitted/received mutually among the individual units.

The central processing unit 2501 is principally constructed of a microprocessor and executes programs stored in the memory unit 2503.

The movie data input unit 2502 inputs movie data of a reproduction objective stored in the memory unit 2503 and besides, when inputting movie data via a network, captures playback objective movie data from a not shown network card such as a LAN card.

The memory unit 2503 is constituted by, for example, a random access memory (RAM), a read only memory (ROM), a hard disk, a DVD or a CD and its drive, a nonvolatile memory such as flash memory or a removable hard disk such as iVDR, and it stores programs executed by the central processing unit 2451, data required by the present movie data playback apparatus such as indexing data 1512, or movie data 2522. FIG. 25 shows that indexing data input program 2511, a keyword list proposal program 2521 and a keyword input program 2531 are stored in the memory unit 2503.

The playback unit 2504 is a unit for decoding movie data inputted by the movie data input unit 2502 and generating video data for display and audio data for output and can be formed as already known hardware or as a program operable in the central processing unit 2501.

The input unit 2505 can be materialized with, for example, a remote controller or a pointing device such as keyboard, mouse or the like and by designating movie data to be played back by the present movie data playback apparatus, it can designate movie data the user views and a keyword to be described later.

The display unit 2506 is materialized with, for example, a display adapter and liquid crystal panel or a projector and displays an image reproduced by the playback unit 2504, a menu necessary for the user to operate the present movie data playback apparatus or a keyword and a slide bar to be described later.

The audio output unit 2507 is materialized with, for example, a sound card, a loudspeaker or the like and outputs a audio reproduced by the playback unit 2504.

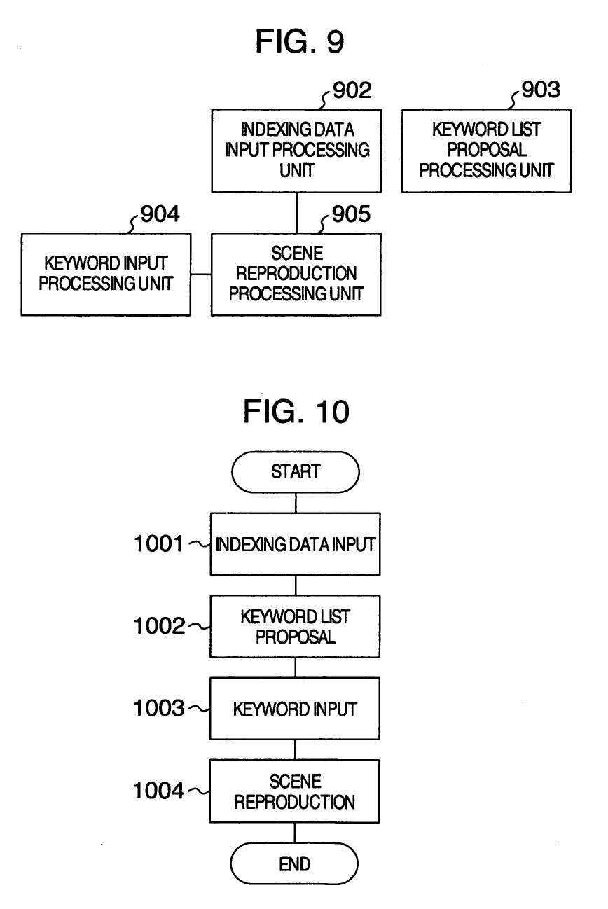

FIG. 9 is a block diagram of the movie data playback apparatus according to the embodiment of the invention.

The construction of the movie data playback apparatus according to the present embodiment will be described using FIG. 9. In FIG. 9, the apparatus comprises an indexing data input processing unit 902 for inputting indexing data of playback objective movie data, a keyword list proposal processing unit 903 for proposing a keyword list of a scene to the user on the basis of the inputted indexing data, a keyword input processing unit 904 for inputting a keyword selected by the user from the proposed keyword list, and a scene reproduction processing unit 905 for acquiring a scene of the inputted keyword from the indexing data and reproducing the scene of the keyword. It will be appreciated that the present playback apparatus is supposed to be provided in advance with a processor for playback movie data, a processor for jumping to a scene at a designated time for playback or a processor for inputting a command from the user such as from the remote controller but these units have already been practiced in normal TV, recorder or computer and are applicable to the apparatus and so will not be described. The central processing unit 2501 explained in connection with FIG. 25 reads individual programs out of the memory unit 2503 to develop the aforementioned processing units on a memory (not shown) and executes the functional block of FIG. 9. In the present embodiment, the individual processing units will be described as being constituted by the software but alternatively, they may individually be materialized as hardware,

Now, in FIG. 9, the indexing data input processing unit 902 inputs indexing data containing a keyword of a scene of playback objective movie data. For example, the indexing data input processing unit 902 inputs indexing data generated through the movie data indexing method of the present invention explained in the first embodiment from the memory unit 2503 or via a network by way of a not shown network data input unit. For example, in the case of recorded movie data, the indexing data input processing unit 902 causes indexing data generated by the movie data indexing method of the present invention to be stored in the memory unit 2503 in the form of a format in which the file name is the same as that of the recorded movie data but only an extension is changed and the present indexing data input processing unit 902 reads the indexing data out of the memory unit 2503 under the name of a file name of the playback movie data, thus realizing the input process by using a scheme of store/read related to the movie data. In an alternative structure, for movie data existing on the network, the movie data is similarly stored by being related to indexing data and upon reading the movie data, the related indexing data may be read out of the not shown network data input processing unit. Otherwise, indexing data may be interleaved so as to be stored in movie data as additional data and the present indexing data input processing unit 902 may read the indexing data from the movie data inputted by the movie data input unit 2502.

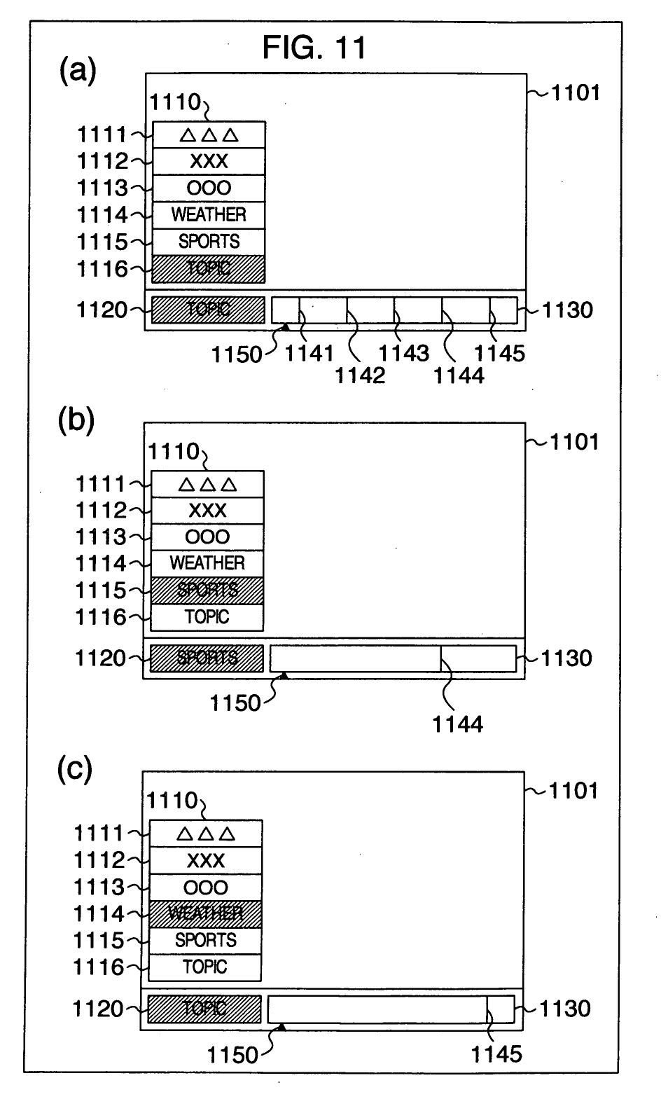

The keyword list proposal processing unit 903 proposes a keyword list of scene to the user on the basis of the inputted indexing data. In this process, a keyword described in the indexing data is read out, for example, when playback of the movie data starts or when the user commands to display the keyword and the keyword is outputted in the form of a list onto the display unit 2506 and then, the display unit 2506 displays it on the display screen. An example of the display screen is illustrated in FIG. 11, which will be detailed later.

With the keyword list displayed on the display unit 2506, the keyword input processing unit 904 inputs, through the medium of the input unit 2505, a keyword selected by the user from the proposed keyword list. For example, when a specified keyword is selected by the input unit 2505 from the keyword list proposed by the keyword list proposal processing unit 903, the keyword input processing unit 904 captures the selected keyword. At that time, the keyword input processing unit 904 may acquire a position of a scene of the inputted keyword by capturing position information 603 of the indexing data and the position (time) may be displayed as a chapter position on a slide bar 1130 in the form of chapter markers (1141 to 1143), for example, as will be described with reference to FIG. 11. Through this, each time that a keyword is selected from the keyword list by means of, for example, an up/down button of the remote controller, the position of the scene is displayed on the slide bar and so, an interface can be provided which can permit the positional relation among scenes to be confirmed by eyes.

The scene reproduction processing unit 905 reproduces the scene of the inputted keyword. For example, the scene reproduction processing unit 905 acquires the position of the scene of the inputted keyword by capturing the position information 603 of the indexing data, jumps to a position temporally succeeding the present reproduction position and nearest thereto within the position (time) and causes the reproduction unit 2504 to perform playback.

Next, flow of the overall operation in the movie data apparatus according to an embodiment of the invention will be described.

FIG. 10 is a flowchart for explaining the operation flow in the movie data playback apparatus according to the embodiment of the invention.

As shown in FIG. 10, in the movie data playback apparatus according to the embodiment of the invention, when playback of movie data is commanded or when the user commands display of a keyword list via the input unit 2505, the indexing data input processing unit 902 inputs indexing data of playback objective movie data (step 1001) and the keyword list proposal processing unit 903 reads keywords described in the indexing data to display them in the form of a list on the display screen of the display unit 2506 (step 1002). Subsequently, when the user selects a keyword, the keyword input processing unit 904 captures the inputted keyword (step 1003), the scene reproduction processing unit 905 acquires a position of a scene of the inputted keyword from the indexing data and the reproduction unit 2504 jumps to a position temporally succeeding the present reproduction position and nearest thereto within the position (time) to perform reproduction (step 1004).

Next, an example of display screen of the movie data playback apparatus will be described.

FIG. 11 is a diagram showing an example of the display screen of the movie data playback apparatus. Designated by 1101 is a movie data display area in which a reproduced image of movie data is displayed. Designated by 1110 is a keyword list display area. The keyword list proposal processing unit 903 outputs keywords described in indexing data in the form of a list to the keyword list display area 1110. Designated by 1111 to 1116 are keyword display areas and the keyword list proposal processing unit 903 displays individual keywords described in the indexing data in the keyword display areas 1111 to 1116. Designated by 1120 is a selected keyword display area in which a keyword the user has selected from the keyword list by means of the keyword input processing unit 904 is displayed. The selected keyword display area 1120 is an area for displaying a keyword which is focused, for example, when the user selects the keyword from the keyword list by means of the up/down bottom of the remote controller. Designated by 1130 is a slide bar adapted to display the reproduction position 1150 at present and a chapter marker to be described later. Designated by 1141 to 1145 are chapter markers adapted to indicate a position of a scene of a selected keyword. Designated by 1150 is a reproduction position at present and by the aid of the chapter markers 1141 to 1145 and the present reproduction position 1150, the positional relationship between the scene of the selected keyword and the present reproduction position can be confirmed. Structurally, in case these indications are displayed upon initiation of the movie data playback or the user commands display of a keyword list by way of the remote controller, for example, playback movie data can be viewed without disturbance, to advantage. In addition, in case the user selects a keyword from the keyword list by means of the up/down bottom of the remote controller, for example, the keyword input processing unit 904 can perform an inversed display of keyword display area of the focused keyword and can display the keyword selected at present in the selected keyword display area 1120, so that the keyword selected at present and a keyword about to be selected can become easily discriminative. In an alternative construction, chapter markers 1141 to 1145 of the scene of the focused keyword may be displayed sequentially on the slide bar 1130 in accordance with movement of the up/down button at that time. Through this, an interface can be provided which can permit the positional relation between a scene of a keyword about to be selected and the present playback position to be confirmed.

For example, a state in which a keyword “topic” 1116 is selected is illustrated at (a) in FIG. 11, with chapter markers 1141 to 1145 corresponding to the scene position of keyword “topic” being displayed. Then, construction may be set up such that as shown at (b) in FIG. 11, when the user makes a focus on a keyword “sports” 1115 by means of, for example, the up/down button of the remote controller, a chapter marker 1144 corresponding to a scene position of keyword “sports” is displayed and when focusing shifts to a keyword “weather” 1114 as shown at (c) in FIG. 11, a chapter marker 1145 corresponding to the scene position of keyword “weather” is displayed. At that time, the playback position 1150 may automatically be shifted to the chapter position of the focused keyword, or the playback position 1150 may be configured so as to shift to the chapter position of the selected keyword when the user commands a decision.

By the movie data playback apparatus described previously, a user interface can be provided which can propose a keyword of a scene in movie data and can enable the user to view easily a scene desired to be watched from the movie data when the user designates a keyword.

### Embodiment 2

Next, a movie data indexing method according to a second embodiment of the present invention will be described with reference to the drawings.

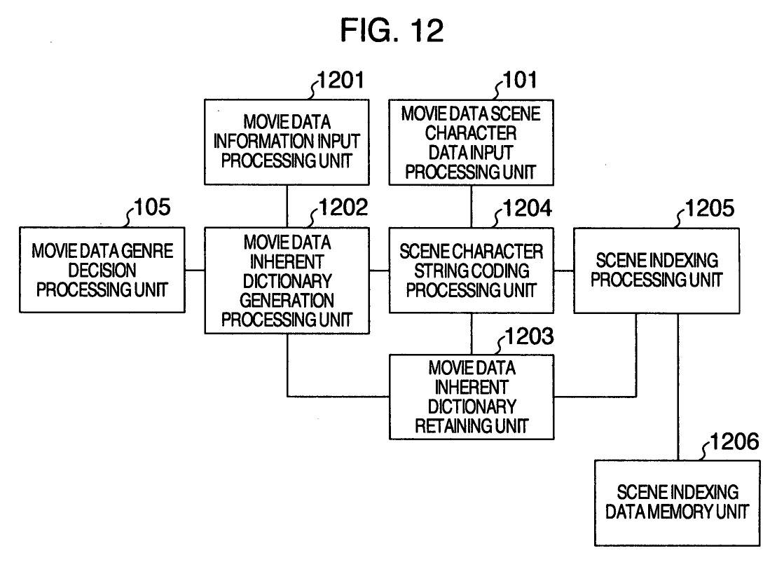

FIG. 12 is a functional block diagram showing the movie data indexing method according to the second embodiment of the invention. The functional block shown in FIG. 12 has a movie data scene character data input processing unit 101, a movie data genre decision processing unit 105, a movie data information input processing unit 1201, a movie data inherent dictionary generation processing unit 1202, a scene character string coding processing unit 102, a scene indexing processing unit 1205, a movie data inherent dictionary retaining unit 1203 and a scene indexing data memory unit. Here, the movie data genre decision processing unit 105 and movie data scene character data input processing unit 101 are similar to those in the first embodiment of the invention and will not be described.

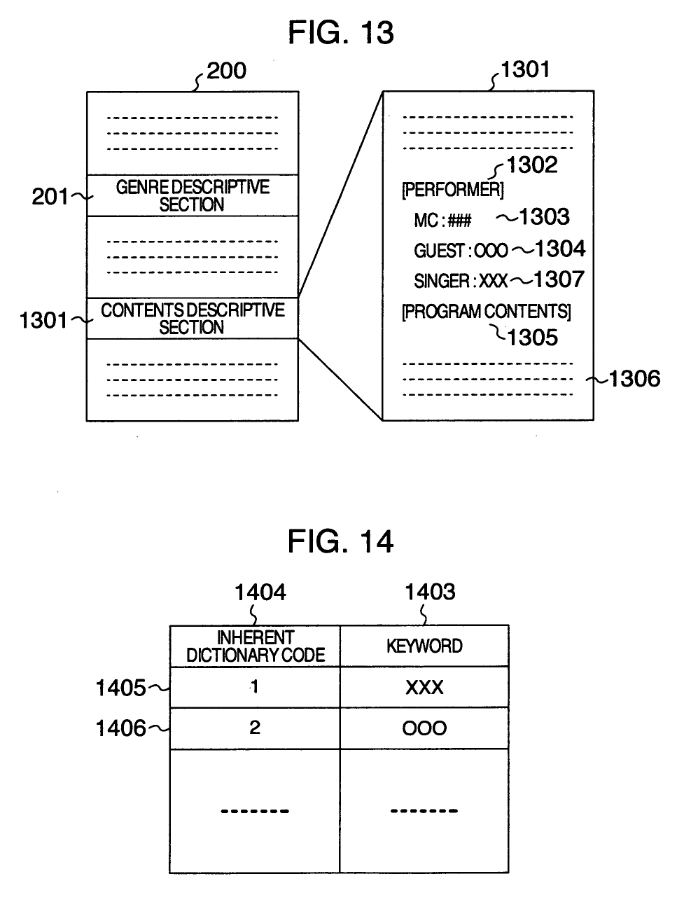

The movie data information input processing unit 1201 inputs movie data information described with information of movie data. The movie data information input processing unit 1201 may be so constructed as to acquire, for example, data described with performers in movie data or, if metadata of movie data is proposed, to acquire the metadata. Alternatively, in the case of television program, SI (Service Information: program information) information of movie data, for example, may be captured. In this case, as shown in FIG. 13, the SI information includes, in addition to the genre descriptive section 201 indicated in FIG. 2, a contents descriptive section 1301 and in the contents descriptive section 1301, a performer tag 1302 and a program contents tag 1305 are present. Further, following the performer tag 1302, names of performers in the movie data such as MC (master of ceremonies) 1303, guest 1304 or singer 1307 are included and therefore, the movie data information input processing unit 1201 may be so constructed as to capture these pieces of information.

The movie data inherent dictionary generation processing unit 1202 generates a dictionary inherent to movie data genre and movie data on the basis of the movie data information inputted by the movie data information input processing unit 1201 and the movie data genre determined by the movie data genre decision processing unit. For example, the movie data information input processing unit 1201 responds to the movie data genre determined by the movie data genre decision processing unit 105 to capture necessary information from the movie data information inputted by the movie data information input processing unit 1201 and generates a dictionary having a set of keyword and a code value as shown in FIG. 14 to be described later. More specifically, in the case of movie data information as shown in FIG. 13, for example, such as having a genre of movie data of music, names of singer 1307 and guest 1304 are used as keywords and the movie data information input processing unit 1201 generates a movie data inherent dictionary by making a set of the keyword and an inherent dictionary code to be recorded in scene character string coded data when the keyword comes up in movie data scene character data, as shown in FIG. 14 to be detailed later. For more details, in the case of, for example, movie information shown in FIG. 13, with the genre of the movie data being music, for example, the movie data information input processing unit 1201 uses person names of singer 1307 and guest 1304 as a key word to generate a movie data inherent dictionary by making a set of the keyword and an inherent dictionary code to be recorded in the scene character string coded data when the keyword comes up in the movie data scene character data, as shown in FIG. 14 to be described later. In the case of the genre of the movie data being a variety, the movie information input processing unit 1201 uses person names of MC 1303 and guest 1304 as a keyword to generate a movie data inherent dictionary by making a set of the keyword and an inherent dictionary code in a similar way and stores the movie data inherent dictionary in the movie data inherent dictionary retaining unit 1203 to permit the scene character string coding processing unit 102 to consult the set as will be described later.

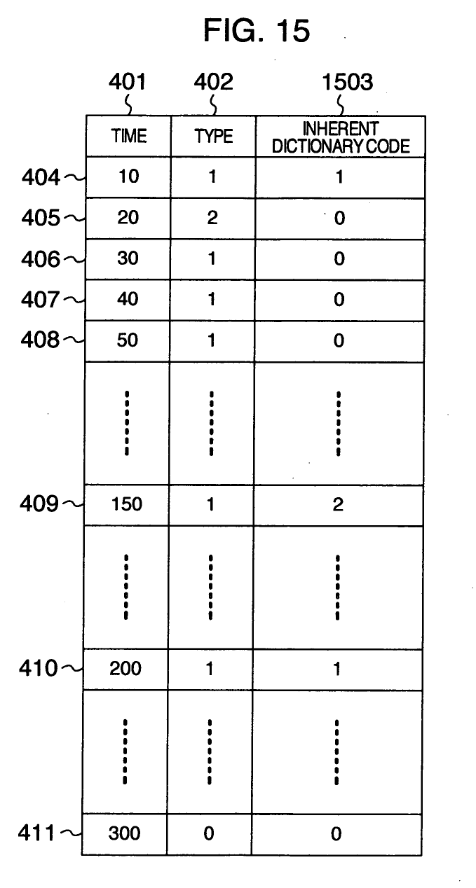

The scene character string coding processing unit 1204 is substantially identical to the scene character string coding processing unit 102 in the first embodiment but in the second embodiment, it consults the movie data inherent dictionary generated by the aforementioned movie data inherent dictionary generation processing unit 1202 in place of the formatted phrase keyword dictionary inputted by the formatted phrase keyword dictionary input processing unit 104 to encode, packet by packet, the movie data scene character data inputted by the movie data scene character data input processing unit 101. Structurally, this is done in such a way that for example, the scene character string coding processing unit 1204 collates each one packet of the movie data scene character data inputted by the movie data scene character data input processing unit 101 with the movie data inherent dictionary generated by the movie data inherent dictionary generation processing unit 102 and when a keyword described in the movie data inherent dictionary comes up in the movie data scene character data, it encodes movie data scene character data of the packet, together with a PTS of movie data scene character data of that packet. More particularly, for example, when such a description that a keyword “x x x” is to be encoded with an inherent dictionary code “1” is given in the movie data inherent dictionary as in the case of a movie data inherent dictionary of FIG. 4 to be detailed later, the scene character string coding processing unit 1204 searches a character string “x x x” in respect of individual packets of the movie data scene character data and when the character string is found, the scene character string coding processing unit 1204 generates scene character string encoded data by describing the inherent dictionary code “1”, together with a PTS of a particular packet of the movie data scene character data, as the scene character string coded data as shown in FIG. 15 to be described later. At that time, in case any keyword in the movie data inherent dictionary comes up, the scene character string coding processing unit 1204 generates scene character string coded data by performing coding throughout the packet. For a packet in which any keyword in the movie data inherent dictionary does not come up, a keyword need not always be included in the scene character string coded data but structurally, it may be included in the scene character string coded data by describing an inherent dictionary code not prescribed in the movie data inherent dictionary (for example, “0”). The present scene character string coding processing unit 102 may encode a specified character string, a mark (for example, musical note mark) and a packet of control code indicative of erase of character string, that is, pieces of information usable regardless of the movie data genre, by codes “2”, “1” and “0”, respectively, thus enabling the genre of the packet to be contained in the scene character string coded data. In any case, the present scene character string coding processing unit 102 collates all packets of movie data scene character data in movie data with the movie data inherent dictionary to generate scene character string coded data.

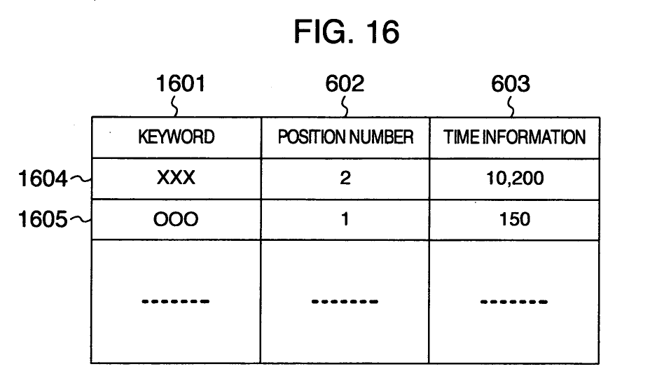

The scene indexing processing unit 1205 is substantially identical to the scene indexing processing unit 103 in the first embodiment but the scene indexing processing unit 1205 in the second embodiment consults the movie data inherent dictionary generated by the aforementioned movie data inherent dictionary generation processing unit 1202 in place of the proposal keyword dictionary for formatted phrase inputted by the proposal keyword dictionary for formatted phrase input processing unit 106 to perform indexing for a scene of movie data, thus generating indexing data. To this end, for example, the scene indexing processing unit 1205 searches, out of the scene character string coded data generated by the scene character string coding processing unit 102, a keyword having the same code value as that of each packet from the movie data inherent dictionary generated by the movie data inherent dictionary generation processing unit 1202. The scene indexing processing unit 1205 generates indexing data by making a set of a keyword extracted as a result of search and time information in the scene character string coded data and by describing the set as the indexing data. The scene indexing data processing unit 1205 stores the thus generated indexing data in the scene indexing data memory unit 1206. More specifically, for example, the scene indexing processing unit 1205 captures an entry 1504 having “1” of inherent dictionary code 1503 from scene character string coded data in FIG. 15 to be described later and searches from the movie data inherent dictionary an entry 1405 having the same inherent dictionary code 1404 as the inherent dictionary code “1” (see FIG. 14 to be described later), thus acquiring the keyword “x x x” described in keyword 1403. Subsequently, the scene indexing processing unit 1205 acquires times “10, 200” of time 1501 having inherent dictionary code “1” of FIG. 15 and describes the keyword “x x x”, times “10, 200” and the number of times as indexing data in keyword 1601, time information 1603 and position number 1602, respectively, as shown in FIG. 16 to be detailed later. The scene indexing processing unit 1205 generates the indexing data by carrying out the present process in respect of entries of all inherent dictionary codes 1503 in the scene character string coded data. The data structure of the indexing data will be described later in greater detail.

Next, the data generated by the movie data indexing method according to the second embodiment will be described in greater detail.

Firstly, the data structure of a movie data inherent dictionary generated by the movie data inherent dictionary generation processing unit 1202 and consulted by the scene character string coding processing unit 102 will be described. As described previously, the present movie data inherent dictionary is so structured as to be generated for each movie data with its genre information determined by the movie data genre decision processing unit 105.

FIG. 14 shows an example of data structure of movie data inherent dictionary and especially, in correspondence with the example of FIG. 13 movie data information, a movie data inherent dictionary for movie data having a genre of movie data “music” is exemplified. In FIG. 14, 1404 designates inherent dictionary code and 1403 designates keyword. Then, 1405 and 1406 each designate an entry of an inherent dictionary code corresponding to an inherent keyword. When a packet containing a character string of “x x x”, for example, is inputted by the movie data scene character data input processing unit 101, the scene character string coding processing unit 102 can generate an inherent dictionary code “1” as scene character string coded data by consulting the present inherent dictionary. Further, the scene indexing processing unit 1205 generates indexing data as a keyword “x x x” for a time of an entry in which the inherent dictionary code “1” of scene character string coded data is applied. Next, the data structure of scene character string coded data generated by the scene character string coding processing unit 102 and consulted by the scene indexing processing unit 1205 will be described.

FIG. 15 shows an example of data structure of scene character string coded data according to the second embodiment of the invention. As shown in FIG. 15, in the scene character string coded data according to the second embodiment, in respect of the scene character string coded data in the first embodiment shown in FIG. 4, the inherent dictionary code 1503 may substitute for the formatted phrase code 403 and the inherent dictionary code may be stored in place of the formatted phrase code. Namely, structurally, 1503 designates a coded value when a keyword of the movie data inherent dictionary is contained in each packet of the movie data scene character data and if a keyword 1403 of the movie data inherent dictionary is found, a value of inherent dictionary code 1404 corresponding to the particular keyword is inputted. In case a keyword 1403 of movie data inherent dictionary is not found, a value not prescribed by the inherent dictionary code 1404 of the move data inherent dictionary (for example, “0” in the case of the example of dictionary in FIG. 14) may be inputted. Further, 404 to 411 designate entries of scene character string coded data in which values corresponding to individual packets of the movie data scene character data are enumerated. Namely, in the example of FIG. 14, it is indicated in the entries 404 and 410 that the scene character string coding processing unit 102 encodes “the movie data scene character data input processing unit 101 has inputted a packet applied with PTS of times “10” and “200” and a character string “x x x” has been contained in the packet.” Further, it is indicated that in the entry 409, a packet applied with a PTS of time “150” has been inputted and a character string “o o o” has been contained in the packet.

Structurally, the scene character string coding processing unit 102 may encode data contained in all packets inputted by the movie data scene character data input processing unit 101 or may encode only a packet containing a keyword of the movie data inherent dictionary. With the present scene character string encoding processing unit 102, the character string per se of the movie data scene character data need not be retained and the memory capacity to be used can be reduced to advantage. Since only keywords inherent to the movie and the genre of the movie data are encoded, the memory capacity to be used can be reduced significantly. Further, since the character string per se of the movie data scene character data is not retained, the structure can be preferable from the viewpoint of copyright protection.

Next, the data structure of indexing data generated by a scene indexing processing unit 1205 according to the second embodiment will be described.

FIG. 16 shows an example of data structure of indexing data according to the second embodiment. As shown in FIG. 16, in the data structure of indexing data according to the second embodiment, a keyword described in keyword 1601 corresponds to a keyword of keyword 1403 prescribed by the movie data inherent dictionary, differing from the formatted phrase code 403 shown in FIG. 4. In this case, the scene indexing processing unit 1205 acquires an inherent dictionary code 1503 and a time 401 from the scene character string coded data, counts a position number by counting the number of entries having the same inherent dictionary code as a particular inherent dictionary code, acquires from the movie data inherent dictionary a keyword 1403 having the same inherent dictionary code 1404 as the particular inherent dictionary code and describes the keyword, the previously counted position number and the times in keyword 1601, position number 602 and time information 603, respectively, thus making it possible to generate indexing data. With the present indexing data, the movie data playback apparatus consulting the indexing data can display a keyword inherent to movie data, for example, a performer name and when the performer name is selected by the user, can display or reproduce a position of a scene associated with the performer.

Next, flow of overall procedures in the movie data indexing method according to the second embodiment will be described.

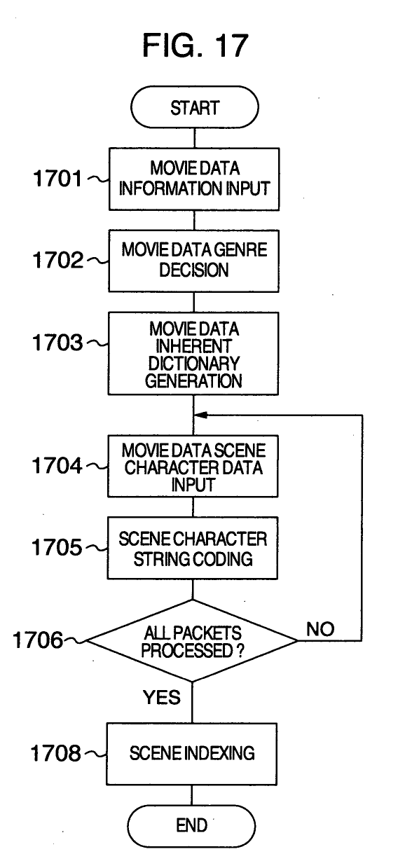

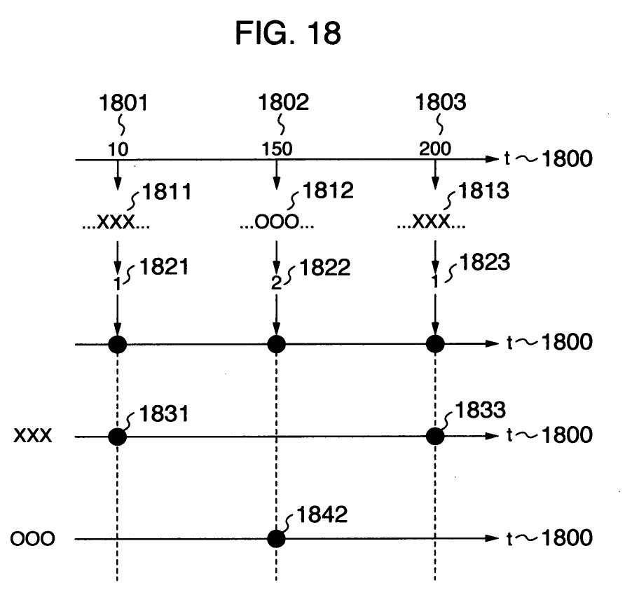

FIG. 17 shows a flowchart for explaining an example of flow of the overall procedures in the movie data indexing method according to the second embodiment. As shown in FIG. 17, in the movie data indexing method according to the second embodiment, the movie data information input processing unit 1201 first inputs movie data information described with information of movie data (step 1701) and the movie data genre decision processing unit 105 decides a genre of the movie data (step 1702). Subsequently, on the basis of the movie data information inputted in step 1702, the movie data inherent dictionary generation processing unit 1202 generates a dictionary inherent to movie data and its genre information, and stores the inherent dictionary in the movie data inherent dictionary retaining unit (step 1703). Thereafter, the movie data scene character data input processing unit 101 inputs character data concerning the movie data scene (movie data scene character data) packet by packet (step 1704), and the scene character string coding processing unit 102 generates scene character string coded data by encoding the movie data scene character data of the packet inputted in step 1704 while consulting the movie data inherent dictionary generated in step 1703 (step 1705).

Then, after movie data scene character data of all packets in the movie data have been encoded by repeating the steps 1704 and 1705 (step 1706), the scene indexing processing unit 1205 performs indexing for the scene of movie data on the basis of the scene character string coded data generated in step 1705 and the movie data inherent dictionary inputted in step 1703, thereby generating indexing data and storing it in the scene indexing data memory unit 1206.

Through this, for movie data having a category of music, for example, movie data scene character data in which character strings 1811 and 1813 termed “x x x” come up at times “10” 1801 and “200” 1803 in the movie data scene character data is encoded as inherent dictionary code “1” 1821 and 1823. Similarly, movie data scene character data at time “150” 1802 at which a character string 1812 of “o o o” comes up in the movie data scene character data can be encoded as an inherent dictionary code “2” 1822 and therefore, the capacity of memory to be used can be reduced in comparison with the case that the character string per se is retained. Further, the scene indexing processing unit 1205 applies an index as a keyword “x x x” 1851 at the positions where the character strings 1811 and 1813 “x x x” come up in the movie data scene character data, thus generating indexing data and applies an index as a keyword “o o o” 1852 at the position where the character string 1812 of “o o o” comes up in the movie data scene character data, thus generating indexing data.

Then, in the present playback unit for reading the indexing data, when the keywords “x x x” 1851 and “o o o” 1852 are proposed to the user and the user designates the keyword “x x x” 1851, movie data is reproduced from the positions of time “10” 1801 or time “200” 1803, thereby ensuring that reproduction from a scene having the keyword of “x x x” 1851 can be performed. Similarly, when the keyword “o o o” 1852 is designated by the user, movie data is reproduced from the positions of time “150” 1802, thereby ensuring that reproduction from a scene having the keyword of “o o o” 1852 can be performed. In FIG. 8, 1800 designates time axis and 1801, 1802 and 1803 designate positions of times “10”, “150” and “200” on time axis, respectively. Further, 1811, 1812 and 1813 designate character strings contained in packets of movie data scene character data and coming up at times “10” 1801, “150” 1802 and “200” 1803, respectively, and 1821, 1822 and 1823 designate inherent dictionary code values of movie data scene character data pieces at 1821, 1822 and 1823, respectively. Further, 1831 and 1833 designate points where a scene of keyword “x x x” 1851 is plotted on time axis and 1832 designates a point where a scene of keyword “o o o” 1851 is plotted on time axis.

According to the second embodiment described previously, the load on the hardware resource can be suppressed and when the user designates a keyword by applying the keyword to a scene of movie data and proposing the keyword, indexing data for enabling the user to view only a desirably watching scene from the movie data can be generated and, especially, because of generation and use of a dictionary inherent to the movie data, a keyword of a scene suitable for movie data of a reproduction objective can be proposed without using more memories than necessary for the dictionary data and the manual update of the dictionary data can be dispensable.

In the movie data playback apparatus according to the second embodiment, the movie data playback unit according to the first embodiment of the invention can be applied as it is and by proposing a keyword of a scene in movie data and letting the user designate the keyword, a scene desired to be watched can be viewed easily.

### Embodiment 3

Next, a movie data indexing method according to a third embodiment of the invention will be described.

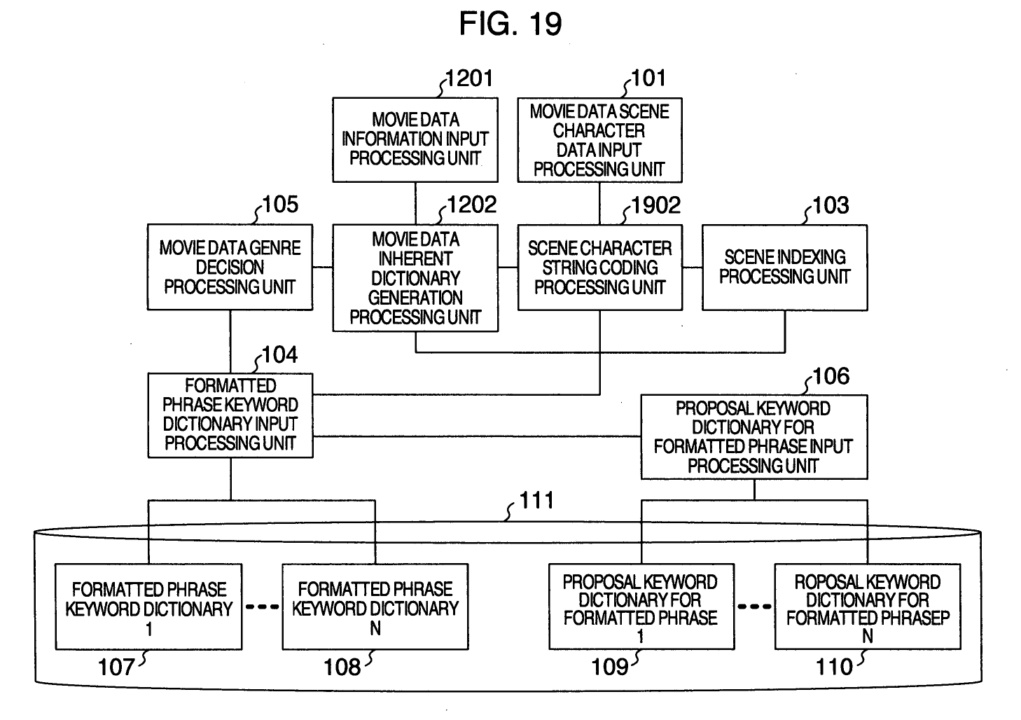

FIG. 19 is a block diagram for the movie data indexing method according to the third embodiment. Provided for the movie data indexing method according to the third embodiment of the invention are, as shown in FIG. 19, a movie data scene character data input processing unit 101, a movie data genre decision processing unit 105, a movie data information input processing unit 1201, a formatted phrase keyword dictionary input processing unit 104, a movie data inherent dictionary generation processing unit 1202, a scene character string coding processing unit 1902, a proposal keyword dictionary for formatted phrase input processing unit 106, a scene indexing processing unit 103, formatted phrase keyword dictionaries 107 to 108 and proposal keyword dictionary for formatted phrase 109 to 110. Here, the movie data genre decision processing unit 105 and movie data scene character data input processing unit 101 are similar to those used in the first and second embodiments of the invention, and the formatted phrase keyword dictionary input processing unit 104, proposal keyword dictionary for formatted phrase input processing unit 106, formatted phrase keyword dictionaries 107 to 108 and proposal keyword dictionary for formatted phrase 109 to 110 as well are like those in the first embodiment of the invention. Further, the movie data information input processing unit 1201 and the movie data inherent dictionary generation processing unit 1202 are like those in the second embodiment of the invention. Although not shown, a movie data inherent dictionary retaining unit 1203 and a scene indexing data memory unit 1206 are also provided.

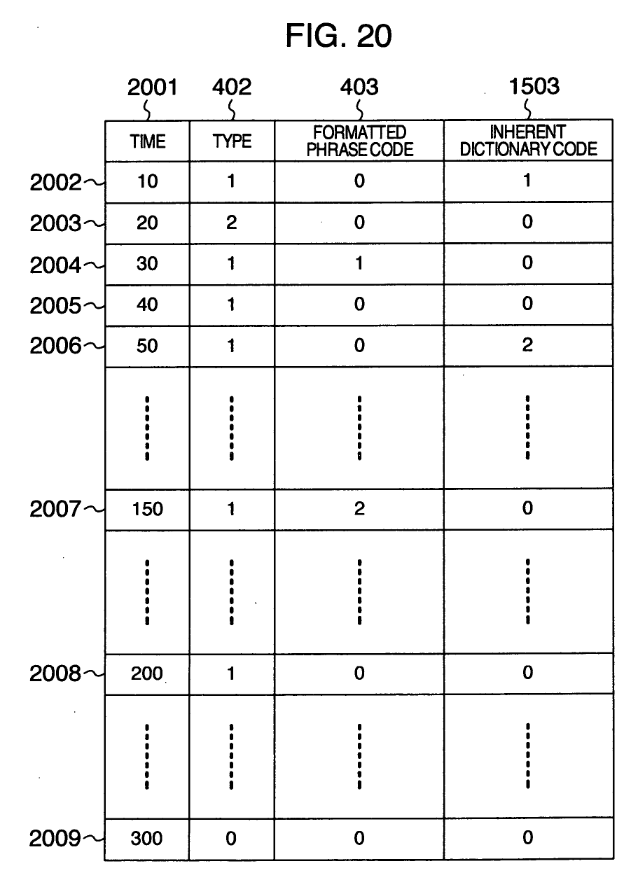

The scene character string coding processing unit 1902 is substantially identical to the scene character string coding processing unit 102 in the first and second embodiments of the invention but in the third embodiment of the invention, it consults a formatted phrase keyword dictionary inputted by the formatted phrase keyword dictionary input processing unit 104 and a movie data inherent dictionary generated by the movie data inherent dictionary generation processing unit 1202 to encode, packet by packet, movie data scene character data inputted by the movie data scene character data input processing unit 101. For example, to this end, the scene character string coding processing unit 1902 is so constructed as to collate movie data scene character data of one packet inputted by the movie data scene character data input processing unit 101 with a formatted phrase keyword dictionary inputted by the formatted phrase keyword dictionary input processing unit 104 and also with a movie data inherent dictionary generated by the movie data inherent dictionary generation processing unit 1202, and when a keyword described in the formatted phrase keyword dictionary or movie data inherent dictionary comes up in the movie data scene character data, encodes the movie data scene character data of the packet, together with a PTS of the movie data scene character data of the packet. More specifically, when a keyword described in the formatted phrase keyword dictionary is found in a packet of movie data scene character data, the scene character string coding processing unit 1902 writes, like the scene character string coding processing unit 102 in the first embodiment of the invention, a formatted phrase code described in the formatted phrase keyword dictionary into formatted phrase code 403 in the scene character string coded data as shown in FIG. 20 to be detailed later. At the same time, if a keyword described in the movie data inherent dictionary is found in a packet of the movie data scene character data, the scene character string coding processing unit 1902 writes, like the scene character string coding processing unit 102 in the second embodiment of the invention, the inherent dictionary code described in the movie data inherent dictionary to inherent dictionary code 1503 in the scene character string coded data as shown in FIG. 20 to be detailed later. For example, when, as in the case of formatted phrase keyword dictionary of FIG. 3A, it is described in the formatted phrase keyword dictionary that a keyword “next” is to be encoded with a formatted phrase code “1”, the scene character string coding processing unit 1902 searches a character string “next” in respect of individual packets of the movie data scene character data and if the character sting is found, it describes a formatted phrase code “1”, together with a PTS of the packet of the movie data scene character data, as a formatted phrase code 403 of scene character string coded data and when, as in the case of the movie data inherent dictionary of FIG. 14, it is described in the movie data inherent dictionary that a keyword “x x x” is to be encoded with an inherent dictionary code “1”, it searches a character string “x x x” in respect of individual packets of the movie data scene character data so that when the character string is found, it may describe the inherent dictionary code “1”, together with a PTS of a packet of the movie data scene character data, as an inherent dictionary code 1503 of the scene character string coded data as shown in FIG. 20 to be detailed later, thus generating scene character string coded data.

The scene indexing processing unit 103 is substantially identical to the scene indexing processing unit 103 in the first embodiment and the scene indexing processing unit 1205 in the second embodiment but in the third embodiment, it is so constructed as to apply indexing to a scene of movie data by consulting a proposal keyword dictionary for formatted phrase inputted by the proposal keyword dictionary for formatted phrase input processing unit 106 and a movie data inherent dictionary generated by the movie data inherent dictionary generation processing unit 1202, thus generating indexing data. For example, to this end, the scene indexing processing unit 103 searches, out of the scene character string coded data generated by the scene character string coding processing unit 102, a keyword having the same code value as that of formatted phrase code 403 and that of inherent dictionary code 1503 of individual packets from the proposal keyword dictionary for formatted phrase inputted by the proposal keyword dictionary for formatted phrase input processing unit 106 and the movie data inherent dictionary generated by the movie data inherent dictionary generation processing unit 1202 as well, so that the scene indexing processing unit 103 generates indexing data by making a set of the particular keyword and time information in the scene character string coded data and describing the set as the indexing data.

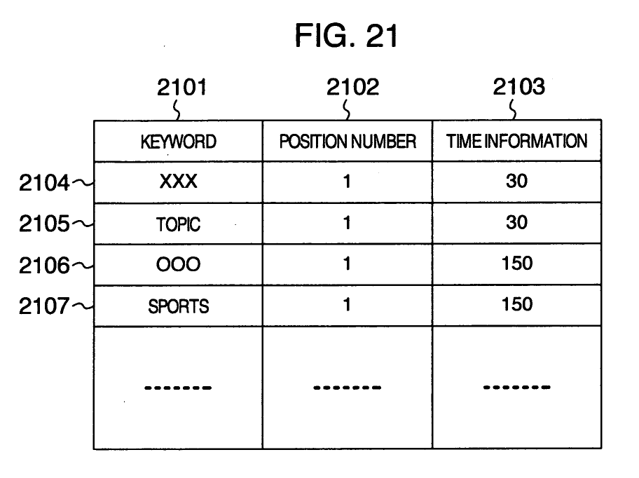

More specifically, for example, the scene indexing processing unit 103 captures an entry 404 having “1” of formatted phrase code 403 from scene character string coded data in FIG. 20 to be described later and searches, from the proposal keyword dictionary for formatted phrase, an entry 503 having the same formatted phrase code 501 as the formatted phrase code “1”, thus acquiring a keyword “topic” described in keyword 502. Subsequently, the scene indexing processing unit 103 acquires time “30” of time 401 having the formatted phrase code “1” and describes the keyword “topic”, times “30” and the number of times as indexing data in keyword 2101, time information 2103 and position number 2102, respectively, as shown in FIG. 21 to be described later. Next, for example, from scene character string coded data in FIG. 20 to be detailed later, an entry 2003 having “1” of inherent dictionary code 1503 is captures and an entry 1405 having the same inherent dictionary code as the inherent dictionary code “1” (for example, 1404 in the case of FIG. 14) is searched from the movie data inherent dictionary to thereby acquire a keyword “x x x” described in keyword 1403. Subsequently, the time “10” of time 2001 having the inherent dictionary code “1” of FIG. 20 is captured and the keyword “x x x”, time “10” and the number of times are described as indexing data in keyword 2101, time information 2103 and position number 2102, respectively, as shown in FIG. 21 to be detailed later. By performing the present process for all entries of formatted phrase code 403 and all entries of inherent dictionary code 1503 in the scene character string coded data, indexing data can be generated.

To add, the particular time of index applied by the inherent dictionary code may be set to a time applied by a formatted phrase keyword dictionary and a proposal keyword dictionary for formatted phrase which come up temporally succeeding the particular time. For example, in the example of FIG. 20, the character string “x x x” is contained in a packet at time “10” in the movie data scene character data and the inherent dictionary code “1” is applied to the entry at time “10” in the scene character string coded data. Further, a character string “next” is contained in a packet at time “30” in the movie data scene character data and a formatted phrase code “1” is applied to an entry at time “30” in the scene character string coded data. The scene indexing processing unit 103 described previously performs indexing of the keyword “x x x” at time “10” but it may also perform indexing of the keyword “x x x” at time succeeding that time and applied by the formatted phrase dictionary and proposal keyword dictionary for formatted phrase, that is, at time “30”. Through this, in case, for example, “x x x” is a performer name, indexing data can be generated which not only indexes simply a scene where the performer appears but also indexes a scene of starting the topic in which the performer acts actually.

Further, this operation may be prescribed by, for example, a movie data inherent dictionary. Structurally, in this case, an attribute is applied following the inherent dictionary code 1404 in FIG. 14, for example, and when this attribute is described with a value meaning correction of the indexing position, indexing of a keyword described in the entry may be performed at a formatted phrase keyword proposal position temporally later than the time at which the keyword comes up.

Further, structurally, indexing may be performed at a formatted phrase keyword proposal position led from a formatted phrase code in which a formatted phrase code coincides with an inherent dictionary code. Through this, when a person name, for example, is selected, viewing from the heading of a topic in which the person comes up can be achieved. Next, data to be generated through the movie data indexing method according to the third embodiment will be described in greater detail. Firstly, the data structure of scene character string coded data according to the third embodiment will be described.

FIG. 20 shows an example of the data structure of scene character string coded data according to the third embodiment. As shown in FIG. 20, in the scene character string coded data according to the third embodiment, the scene character string coded data in the first embodiment of the invention is added with inherent dictionary code 1503 of scene character string coded data according to the second embodiment of the invention. Then, structurally, when a keyword of the formatted phrase keyword dictionary is contained in each packet of movie data scene character data, a value of formatted phrase code 303 in formatted phrase keyword dictionary corresponding to the keyword of interest is inputted and when a keyword of the movie data inherent dictionary has been contained in each packet of the movie data scene character data, a value of inherent dictionary code 1404 of movie data keyword dictionary corresponding to the keyword of interest is inputted. In other cases, operation may be carried out similarly to the first and second embodiments of the invention. In FIG. 20, if the figure is supposed to be based on the formatted phrase keyword dictionary in FIGS. 3A and 3B and the movie data inherent dictionary in FIG. 14, the inherent dictionary code at time “10” is “1”, indicating that a character string “x x x” has been contained in a packet at time “10” in the movie data scene character data, and the formatted phrase code is “1” at time “30”, indicating that a character string “next” is contained in a packet at time “30” in the movie data scene character data. Similarly, the inherent dictionary code at time “50” is “2”, indicating that a character string “o o o” is contained in a packet at time “50” in the movie data scene character data and the formatted phrase code is “2” at time “150”, indicating that a character string “Sport.” has been contained in a packet at time “150” in the movie data scene character data, Next, the data structure of indexing data according to the third embodiment will be described.

FIG. 21 shows an example of the data structure of indexing data according to the third embodiment. As shown in FIG. 21, the data structure per se of indexing data according to the third embodiment is identical to the data structure of indexing data according to the first and second embodiments of the invention but as a keyword described in keyword 1601, the keyword 502 prescribed by the proposal keyword dictionary for formatted phrase and the keyword 1403 prescribed by the movie data inherent dictionary coexist. To add, in FIG. 21, the particular time of index applied by the inherent dictionary code may be set to a time applied by a formatted phrase keyword dictionary and a proposal keyword dictionary for formatted phrase which come up temporally succeeding the particular time and the time information of keyword “x x x” is not set to “10” but set to a position where a keyword of the succeeding formatted phrase keyword dictionary comes up, that is, time information “30” of a keyword “topic”. Similarly, the time information of keyword “o o o” is not “50” but set to a position where a keyword of the succeeding formatted phrase keyword dictionary comes up, that is, time information “150” of a keyword “sports”.

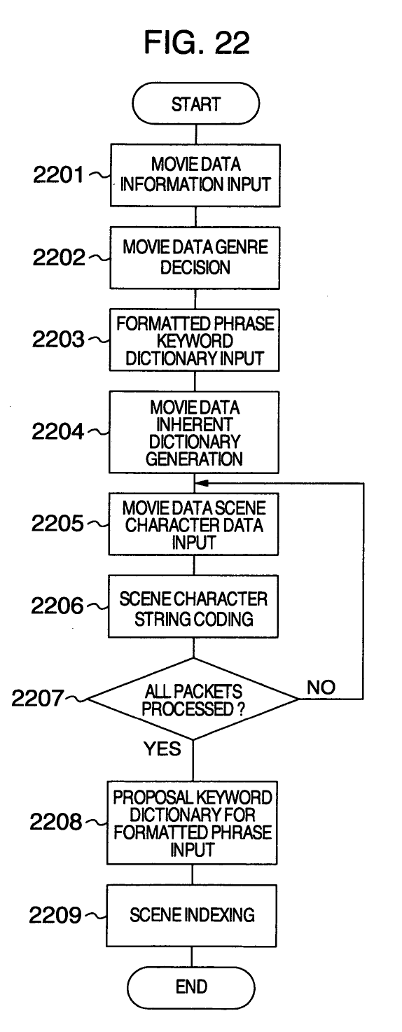

Next, flow of the overall procedures in the movie data indexing method according to the third embodiment will be described. FIG. 22 is a flowchart for explaining an example of the overall process flow in the movie data indexing method according to the third embodiment.

As shown in FIG. 22, in the movie data indexing method according to the third embodiment, the movie data information input processing unit 1201 first inputs movie data information described with information of movie data (step 2201) and the movie data genre decision processing unit 105 decides a genre of the movie data (step 2202). Subsequently, the formatted phrase keyword dictionary input processing unit 104 inputs a formatted phrase keyword dictionary inherent to the movie data genre determined in step 2202 (step 2203) and thereafter, the movie data inherent dictionary generation processing unit 1202 generates, on the basis of the movie data genre determined in step 2202 and the movie data information inputted in step 2201, a dictionary inherent to the movie data genre and the movie data (step 2204). Subsequently, the movie data scene character data input processing unit 101 inputs character data concerning a movie data scene (movie data scene character data) packet by packet (step 2204) and the scene character string coding processing unit 102 generates scene character string coded data by encoding the movie data scene character data inputted in step 2205 while consulting the formatted phrase keyword dictionary inputted in step 2203 and the movie data inherent dictionary generated in step 2204 (step 2206),

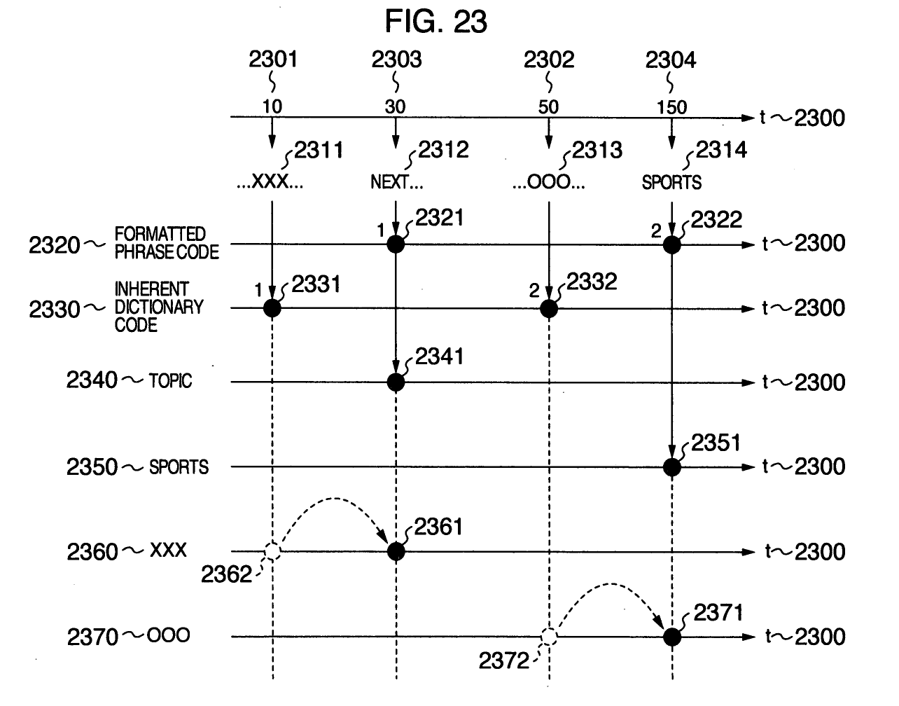

Then, after pieces of movie data scene character data of all packets in the movie data have been encoded by repeating the steps 2205 and 2206 (step 2207), the proposal keyword dictionary for formatted phrase input processing unit 106 inputs a proposal keyword dictionary for formatted phrase corresponding to a formatted phrase keyword dictionary inherent to the movie data genre determined in step 2202 (namely, prescribing a keyword to be proposed to the formatted phrase keyword dictionary) (step 2208) and the scene indexing processing unit 103 performs indexing for a scene of the movie data on the basis of the scene character string code generated in step 2206, the proposal keyword dictionary for formatted phrase inputted in step 2208 and the movie data inherent dictionary generated in step 2204, thus generating indexing data (step 2209). For example, for movie data having a category of news, the scene indexing processing unit 103 encodes, in respect of movie data scene character data at time “30” 2303 at which a character string 2312 of “next” comes up in the movie data scene character data as shown in FIG. 23, a formatted phrase code 2320 as “1” 2321 and encodes, in respect of movie data scene character data at time “150” 2304 at which a character string 150 of “Sports.” comes up in the movie data scene character data, a formatted phrase code 2320 as “2” 2322. Further, for movie data scene character data at time “10” 2301 at which a character string 2311 termed “x x x” comes up in the movie data scene character data, the scene indexing processing unit 103 encodes an inherent dictionary code 2320 as “1” 2331 and similarly, for movie data scene character data at time “50” 2302 at which a character string 2313 termed “o o o” comes up in the movie data scene character data, encodes an inherent dictionary code 2320 as “2” 2332. Then, the indexing processing unit 103 generates indexing data in which an index is applied as keyword “topic” 2340 at a position 2341 where a character string 2312 “next” comes up in the movie data scene character data and an index is applied as keyword “sports” 2361 at a position 2351 where a character string 2314 “Sports.” comes up in the movie data scene character data. Further, the indexing processing unit 103 generates indexing data in which an index is applied as keyword “x x x” 2360 at a position 2362 where a character string 2311 “x x x” comes up in the movie data scene character data and an index is applied as keyword “o o o” 2370 at a position 2372 where a character string “o o o” 2313 comes up in the movie data scene character data. At that time, as described previously, indexing data is generated in which the keyword “x x x” is indexed at a position 2361 by setting the time of index applied by the inherent dictionary code to a time applied by temporally succeeding formatted phrase keyword dictionary and proposal keyword dictionary for formatted phrase. Further, the scene indexing processing unit 103 generates similarly indexing data in which a keyword “o o o” 2370 is indexed at a position 2371. Through this, when the user selects a keyword of person name “x x x”, for example, viewing from the heading of a topic in which the person appears can be achieved in the movie data playback apparatus reading the present indexing data.

As described above, in the movie data playback apparatus reading indexing data generated through the indexing method of the third embodiment of the invention, when formatted keywords such as “topic” 2340 and “sports” 2350 and keywords “x x x” 2360 and “o o o” 2370 as well are proposed to the user and these keywords are designated by the user, reproduction from scenes of the respective keywords can be carried out by reproducing the movie data from the positions where the individual keywords are indexed.

In FIG. 23, 2300 designates time axis and 2301, 2302, 2303 and 2304 designate positions of times “10”, “30”, “50” and “150” on time axis, respectively. Further, 2311, 2312, 2313 and 2314 designate character strings contained in packets of movie data scene character data at times “10” 2301, “30” 2303, “50” 2302 and “150” 2304, respectively, and 2321 and 2322 designate values and temporal positions of formatted phrase code 2320 of movie data scene character data pieces 2312 and 2314, respectively. Further, 2331 and 2332 designate values and temporal positions of inherent dictionary code 2330 of movie data scene character data pieces 2311 and 2312, respectively. Then, 2341 designates a point where an index position of a keyword “topic” 2340 is plotted on time axis and 2351 designates a point where an index position of a keyword “sports” 2350 is plotted on time axis. Further, 2362 and 2361 designate points where an index position of a keyword “x x x” 2360 is plotted on time axis and especially, 2361 designates a position when the time of index applied by the inherent dictionary code is set to a time applied by temporally succeeding formatted phrase keyword dictionary and proposal keyword dictionary for formatted phrase. Further, 2372 and 2371 designate points where an index position of a keyword “o o o” 2370 is plotted on time axis and especially, 2371 designates a position when the time of index applied by the inherent dictionary code is set to a time applied by temporally succeeding formatted phrase keyword dictionary and proposal keyword dictionary for formatted phrase.

According to the movie data indexing method of the third embodiment of the invention described previously, the load on the hardware resource can be suppressed, and when the user designates a keyword by applying the keyword to a scene of movie data and proposing the keyword, indexing data for enabling the user to view only a desirably watching scene from the movie data can be generated and, especially, by generating and using a dictionary inherent to a genre of the movie data and a dictionary inherent to the movie data, a keyword of a scene suitable for the movie data can be proposed and the manual update of the dictionary data can be dispensable.

To add, in the movie data playback apparatus according to the third embodiment, the movie data playback unit according to the first and second embodiments of the invention can be applied as it is and by proposing a keyword of a scene in movie data and letting the user designate the keyword, a scene desired to be watched from the movie data can be viewed easily.

Finally, an example of the hardware construction of an indexing apparatus for realizing the indexing method will be described.

FIG. 24 shows an example of the hardware construction of an indexing apparatus for materializing the indexing method. As shown in FIG. 24, the indexing apparatus for materializing the indexing method of the invention is constructed by having a central processing unit 2401, a movie data input processing unit 2402 and a memory unit 2403. Then, structurally, the individual units are coupled by means of a bus 2404 so that data may be transmitted/received mutually among the individual units. The movie data input unit 2402 inputs movie data stored in the memory unit 2403, or when inputting movie data via a network, it acquires movie data from a not shown network card such as LAN card.

The memory unit 2403 is constituted by, for example, a random access memory (RAM), a read only memory (ROM), a hard disk, DVD or CD and its drive, or a nonvolatile memory such as flash memory or a removable hard disk such as iVDR and stores programs executed by the central processing unit 2401, data required by the present indexing method or movie data.

The central processing unit 2401 is principally constructed of a microprocessor and executes programs stored in the memory unit 2403. In the present construction, by constituting the processing units (individual processing units in FIG. 1, FIG. 12 or FIG. 19) in the aforementioned indexing method as programs executable by the central processing unit 2401, the indexing apparatus for realizing the indexing method of the invention can be materialized. For example, the individual programs 2413, 2423, 2433, 2443, 2453 and 2463 and the formatted phrase keyword dictionary 2414 and proposal keyword dictionary for formatted phrase 2424 as well shown in FIG. 24 are stored in the memory unit 2403. The central processing unit 2401 may call the individual programs and constitute the individual processing units in FIG. 1, 12 or 19. While in the foregoing the processing units for use in the indexing method (the individual processing units in FIG. 1, 12 or 19) have been explained as being materialized exemplarily as programs executed by the central processing unit 2401, the individual processing units may of course be constituted by hardware. According to the various embodiments set forth so far, indexing data applying a keyword to a scene of movie data can be generated by which the capacity of dictionary data can be reduced when extracting a keyword for a movie data scene, thereby reducing the memory capacity for retaining the dictionary data as far as possible, and besides manual update of the dictionary data can be dispensed with. Further, by providing a user interface in which a keyword is applied to a scene of movie data and a reproduction position is proposed together with the keyword, selection of a scene by the user can be carried out with more ease.

The indexing apparatus and the movie data playback apparatus have been described by way of example of separately constructed apparatus but the indexing process and the reproduction process may be incorporated in a single apparatus.

It should be further understood by those skilled in the art that although the foregoing description has been made on embodiments of the invention, the invention is not limited thereto and various changes and modifications may be made without departing from the spirit of the invention and the scope of the appended claims.

1. A movie data indexing method for performing indexing of movie data comprising a movie data scene character data input step for inputting character data concerning a movie data scene, a movie data genre decision step for deciding a genre of movie data, a formatted phrase keyword dictionary input step for inputting a formatted phrase keyword dictionary inherent to the determined movie data genre, a scene character string coding step for generating scene character string coded data by encoding a character string for a scene of movie data on the basis of the inputted formatted phrase keyword dictionary and said inputted movie data scene character data, proposal keyword dictionary for formatted phrase input step for inputting a dictionary prescribing a keyword to be proposed to said formatted phrase keyword dictionary and a scene indexing step for generating scene indexing data by performing indexing to a scene of movie data on the basis of said scene character string coded data and said inputted proposal keyword dictionary for formatted phrase, whereby the scene indexing data applying a keyword to a scene of the movie data is generated with dictionary data of small capacity and by dispensing with manual update of the dictionary data.

2. A movie data indexing method for performing indexing of movie data comprising a movie data scene character data input step for inputting character data concerning a movie data scene, a movie data genre decision step for deciding a genre of movie data, a movie data information input step for inputting movie data information described with information of the movie data, a movie data inherent dictionary generation step for generating a dictionary inherent to the movie data on the basis of the inputted movie data information, a scene character string coding step for generating scene character string coded data by encoding a character string for a scene of movie data on the basis of the generated movie data inherent dictionary and said inputted movie data scene character data, and a scene indexing step for generating scene indexing data by performing indexing to a scene of the movie data on the basis of the scene character string coded data and said generated movie data inherent dictionary, whereby the scene indexing data applying a keyword to a scene of the movie data is generated with dictionary data of small capacity and by dispensing with manual update of the dictionary data.

3. A movie data indexing method for performing indexing of movie data comprising a movie data scene character data input step for inputting character data concerning a movie data scene, a movie data genre decision step for deciding a genre of movie data, a formatted phrase keyword dictionary input step for inputting a formatted phrase keyword dictionary inherent to the determined movie data genre, a movie data information input step for inputting movie data information described with information of the movie data, a movie data inherent dictionary generation step for generating a dictionary inherent to the movie data on the basis of the inputted movie data information, a scene character string coding step for generating scene character string coded data by encoding a character string for a scene of movie data on the basis of the generated movie data inherent dictionary, said inputted formatted phrase keyword dictionary and said inputted movie data scene character data, aproposal keyword dictionary for formatted phrase input step for inputting a dictionary prescribing a keyword to be proposed to said formatted phrase keyword dictionary and a scene indexing step for generating scene indexing data by performing indexing to a scene of the movie data on the basis of said scene character string coded data, said generated movie data inherent dictionary and said inputted proposal keyword dictionary for formatted phrase.

4. A movie data indexing method according to claim 2, wherein said movie data information input step inputs, as the movie data information described with information of the movie data, SI information concomitant to the movie data.

5. A movie data indexing method according to claim 2, wherein said movie data information input step inputs, as the movie data information described with information of the movie data, metadata concerning the movie data.

6. A movie data indexing method according to claim 1, wherein said movie data scene character data input step acquires a character string of subtitle data which is concomitant to the movie data.

7. A movie data indexing method according to claim 1, wherein said movie data scene character data input step inputs an OCR result of a telop image overlaid on an image of the movie data.

8. A movie data indexing method according to claim 1, wherein said movie data scene character data input step inputs a character string as a result of speech recognition of the movie data.

9. A movie data indexing method according to claim 1, wherein said movie data scene character data input step inputs metadata of the movie data.

10. A movie data playback apparatus for reproducing movie data comprising an indexing data input processing unit for inputting indexing data containing a keyword for a scene of movie data of a reproduction objective, a keyword list output processing unit for outputting to a display unit a keyword list of a scene on the basis of the inputted indexing data, a keyword input processing unit for inputting a keyword selected from the outputted keyword list, and a scene reproduction processing unit for acquiring a scene of said keyword from the inputted keyword and said indexing data to reproduce a scene of the keyword.

11. A movie data playback apparatus according to claim 10 further comprising a bar output processing unit for outputting to the display unit a slide bar indicative of a reproduction position, wherein when receiving a keyword input from the keyword input processing unit, said bar output processing unit displays a position of the selected keyword on said slide bar.
